(19) United States
(12) Patent Application Publication
(10) Pub. No.: US 2024/0238911 A1
(43) Pub. Date: Jul. 18, 2024

(54) CONDUCTIVE COMPOSITION, CONDUCTIVE LAYER AND ELECTRONIC DEVICE EMPLOYING THE SAME

(71) Applicant: INDUSTRIAL TECHNOLOGY RESEARCH INSTITUTE, Hsinchu (TW)

(72) Inventors: Yi-Chi YANG, New Taipei City (TW); Jyh-Long JENG, New Taipei City (TW)

(73) Assignee: INDUSTRIAL TECHNOLOGY RESEARCH INSTITUTE, Hsinchu (TW)

(21) Appl. No.: 18/512,534

(22) Filed: Nov. 17, 2023

(30) Foreign Application Priority Data
Dec. 29, 2022 (TW) 111150527

(51) Int. Cl. B23K 35/02; B22F 1/052; B22F 1/102; B22F 1/103; B22F 3/10; H01B 1/22

(52) U.S. Cl. CPC B23K 35/025; B22F 1/052; B22F 1/102; B22F 1/103; B22F 3/10; H01B 1/22; B22F 2301/255; B22F 2302/45; B22F 2304/10; B22F 2999/00

(57) ABSTRACT

A conductive composition, conductive layer and electronic device employing the same are provided. The conductive composition includes 3-7 parts by weight of a component (A) and 93-97 parts by weight of a component (B). The component (A) is an epoxy compound, wherein the epoxy compound is a compound having at least one glycidyloxycarbonyl group. The component (B) includes a first metal particle, wherein the first metal particle has a particle size distribution D90 that is less than or equal to 1 μm. The total weight of the component (A) and component (B) is 100 parts by weight.

### CROSS REFERENCE TO RELATED APPLICATIONS

This application claims priority of Taiwan Patent Application No. 111150527, filed on Dec. 29, 2022, the entirety of which is incorporated by reference herein.

### TECHNICAL FIELD

The disclosure relates to a conductive composition, conductive layer, and electronic device employing the same.

### BACKGROUND

### Field of the Invention

In the field of semiconductor packaging and power semiconductor device carrier applications, power density per unit volume increases when the electronic device structures become smaller and more complex in function. Therefore, more effective heat dissipation is required.

### Description of the Related Art

The use of conventional solder paste as the bonding material in electronic devices may incur problems such as solder creep and reduced reliability, especially when the operating temperature of the device approaches the melting point of the solder paste. Although a high melting point alloy (such as gold germanium (AuGe), gold silicon (AuSi), gold indium (AuIn) and zinc aluminum (ZnAl)) has a higher melting point than solder paste, their processing temperatures are also too high. Therefore, electronic devices may become damaged due to the use of such alloy materials with a higher melting point.

Conductive adhesive has been proposed as a replacement for solder paste as the bonding material in electronic devices. Conductive adhesive is generally divided into two types: namely, high-temperature conductive adhesive and low-temperature conductive adhesive. However, the processing temperature of high-temperature conductive adhesive is still too high for temperature-sensitive electronic devices. Additionally, due to the rigidity and brittleness of the cured high-temperature conductive adhesive, there is the risk of fracture under excessive stress. In addition, although the low-temperature conductive adhesive has a lower processing temperature, conventional low-temperature conductive adhesives bond under pressure or the addition of inorganic powder to avoid the formation of void defects. This bonding process under pressure can easily damage electronic devices, and the addition of inorganic powder into the conductive composition of the conductive adhesive can lead to problems with the aggregation of the inorganic powder due to poor dispersion uniformity.

Therefore, a novel conductive composition is called for to solve the aforementioned problems.

### BRIEF SUMMARY OF THE INVENTION

According to embodiments of the disclosure, the disclosure provides a conductive composition that includes 3 to 7 parts by weight of a component (A) and 93 to 97 parts by weight of a component (B). The component (A) is an epoxy compound, wherein the epoxy compound is a compound having at least one glycidyloxycarbonyl group. The component (B) includes a first metal particle, wherein the first metal particle has a particle size distribution D90 that is less than or equal to 1 μm, wherein the total weight of the component (A) and component (B) is 100 parts by weight.

According to embodiments of the disclosure, the disclosure also provides a conductive layer, wherein the conductive layer may be a product of the conductive composition of the disclosure obtained via a sintering process.

According to embodiments of the disclosure, the disclosure also provides an electronic device, wherein the conductive layer of the electronic device may be a product of the conductive composition of the disclosure obtained via a sintering process.

### BRIEF DESCRIPTION OF THE DRAWINGS

The present invention can be more fully understood by reading the subsequent detailed description and examples with references made to the accompanying drawings, wherein:

FIG. 1 is a cross-sectional view of the electronic device 100 according to embodiments of the disclosure.

FIG. 2 is a field emission scanning electron microscope (FESEM) image of silver particle (LS0305@PA01).

FIG. 3 is a field emission scanning electron microscope (FESEM) image of silver particle (LS0305@PA01) mixed with glycidyl ester epoxy compound after sintering process.

FIG. 4 is a field emission scanning electron microscope (FESEM) image of Silver Metal particle (2).

FIG. 5 is a field emission scanning electron microscope (FESEM) image of Silver Metal particle (2) mixed with glycidyl ester epoxy compound (jER871) after sintering process.

FIG. 6 is a field emission scanning electron microscope (FESEM) image of silver particle (LS0305@HA05).

FIG. 7 is a field emission scanning electron microscope (FESEM) image of silver particle (LS0305@HA05) mixed with glycidyl ester epoxy compound (jER871) after sintering process.

FIG. 8 is a field emission scanning electron microscope (FESEM) image of Silver Metal particle (3).

FIG. 9 is a field emission scanning electron microscope (FESEM) image of Silver Metal particle (3) mixed with glycidyl ester epoxy compound (jER871) after sintering process.

FIG. 10 is a field emission scanning electron microscope (FESEM) image of silver particle (LS0305@SA05) mixed with glycidyl ester epoxy compound (jER871) after sintering process.

FIG. 11 is a field emission scanning electron microscope (FESEM) image of the metal particle prepared by subjecting Combination (1) to a sintering process.

FIG. 12 is a field emission scanning electron microscope (FESEM) image of the metal particle prepared by subjecting Combination (2) to a sintering process.

FIG. 13 is a field emission scanning electron microscope (FESEM) image of the metal particle prepared by subjecting Combination (3) to a sintering process.

FIG. 14 is a field emission scanning electron microscope (FESEM) image of the metal particle prepared by subjecting Combination (4) to a sintering process.

FIG. 15 is a field emission scanning electron microscope (FESEM) image of the metal particle prepared by subjecting Combination (5) to a sintering process.

FIG. 16 is a field emission scanning electron microscope (FESEM) image of the metal particle prepared by subjecting Combination (6) to a sintering process.

FIG. 17 is a field emission scanning electron microscope (FESEM) image of the metal particle prepared by subjecting Combination (7) to a sintering process.

FIG. 18 is a field emission scanning electron microscope (FESEM) image of the metal particle prepared by subjecting Combination (8) to a sintering process.

FIG. 19 is a field emission scanning electron microscope (FESEM) image of the metal particle prepared by subjecting Combination (9) to a sintering process.

FIGS. 20-28 are Fourier transform infrared spectra of various epoxy resins before and after mixing with metal particles.

### DETAILED DESCRIPTION OF DISCLOSED EMBODIMENTS

The conductive composition, conductive layer, and electronic device employing the same of the disclosure are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. As used herein, the term “about” in quantitative terms refers to plus or minus an amount that is general and reasonable to persons skilled in the art.

Further, the use of ordinal terms such as “first”, “second”, “third”, etc., in the disclosure to modify an element does not by itself connote any priority, precedence, order of one claim element over another or the temporal order in which it is formed, but are used merely as labels to distinguish one claim element having a certain name from another element having the same name (but for use of the ordinal term) to distinguish the claim elements.

It should be noted that the elements or devices in the drawings of the disclosure may be present in any form or configuration known to those skilled in the art. In addition, the expression “a layer overlying another layer”, “a layer is disposed above another layer”, “a layer is disposed on another layer”, and “a layer is disposed over another layer” may refer to a layer that directly contacts the other layer, and they may also refer to a layer that does not directly contact the other layer, there being one or more intermediate layers disposed between the layer and the other layer.

The drawings described are only schematic and are non-limiting. In the drawings, the size, shape, or thickness of some of the elements may be exaggerated and not drawn on scale for illustrative purposes. The dimensions and the relative dimensions do not correspond to actual location to practice of the disclosure. The disclosure will be described with respect to particular embodiments and with reference to certain drawings but the disclosure is not limited thereto.

The disclosure provides a conductive composition, conductive layer, and electronic device employing the same. According to embodiments of the disclosure, the conductive composition includes an epoxy compound and a metal particle. By means of the coordination between the specific epoxy compound and the metal particle having a specific residual percentage (of the modified layer on the surface of the metal particle) and particular size, the diffusion distance between metal particles in the conductive composition of the disclosure is effectively increased after subjecting to a sintering process (such as atmospheric pressure sintering process), thereby improving the sintering properties of the metal particle. As a result, the metal particles of the obtained conductive layer (i.e. sinter) are apt to bond together after sintering process (i.e. sintering combination). When the sintering combination between the metal particles in the conductive layer becomes more obvious, the gaps formed by the powder stacking will become smaller, resulting in a denser conductive layer. Therefore, the conductive layer of the disclosure exhibits a higher thermal conductivity coefficient, higher shear strength and lower resistivity.

According to embodiments of the disclosure, the conductive composition of the disclosure has a lower processing temperature (such as 180° C. to 220° C.) and can be subjected to a sintering process at atmospheric pressure (i.e. without pressurization during sintering process) to form a conductive layer. Further, the conductive composition can be used without including inorganic powders and is suitable for forming conductive layers in electronic devices to electrically connect other elements.

According to embodiments of the disclosure, the conductive composition of the disclosure includes 3 to 7 parts by weight (such as 4 parts by weight, 5 parts by weight, or 6 parts by weight) of a component (A) and 93 to 97 parts by weight (such as 94 parts by weight, 95 parts by weight, or 96 parts by weight) of a component (B). The component (A) is an epoxy compound, wherein the epoxy compound is a compound having at least one glycidyloxycarbonyl group. The component (B) includes a first metal particle. When the amount of epoxy compound in the conductive composition of the disclosure is too high, the sintering properties of metal particle are deteriorated (i.e. the metal particles still remain in the form of a particle after sintering process) since the metal particle is covered by excessive epoxy compound. When the amount of epoxy compound in the conductive composition of the disclosure is too low, the conductive composition would not form the conductive layer due to the increased viscosity of conductive composition, when the conductive composition has a low amount of solvent.

According to embodiments of the disclosure, the total weight of the component (A) and component (B) is 100 parts by weight.

According to embodiments of the disclosure, in order to form the coordination between the metal particles of the composition, the epoxy compound of the disclosure should have a specific structure (i.e. having at least one glycidyloxycarbonyl group). According to embodiments of the disclosure, the epoxy compound of the disclosure can coordinate with specific metal particles (such as metal particle having a particle size distribution D90 less than or equal to 1 m), thereby causing a blue shift in the carbonyl signal of the epoxy compound in FT-IR spectrum. According to embodiments of the disclosure, the epoxy compound may be a compound having one glycidyloxycarbonyl group, such as 2,3-epoxypropyl formate, glycidyl acrylate, glycidyl methacrylate, glycidol acetate, glycidyl butyrate, glycidyl benzoate, neodecanoic acid glycidyl ester, palmitic acid glycidyl ester, stearic acid glycidyl ester, oleic acid glycidyl ester, linoleic acid glycidyl ester, linolenic acid glycidyl ester, dimer acid glycidyl ester having a glycidyloxycarbonyl group, polyacrylate having a glycidyloxycarbonyl group, polymethacrylate having a glycidyloxycarbonyl group, or a combination thereof.

According to embodiments of the disclosure, the epoxy compound may be a compound having at least two glycidyloxycarbonyl groups, such as bis(oxiranylmethyl) oxalate, diglycidyl 1,2-cyclohexane dicarboxylate, bis(2,3-epoxy propyl)cyclohex-4-ene-1,2-dicarboxylate, 4,5-epoxytetrahydrophthalic acid diglycidyl ester, bis(2,3-epoxypropyl) phthalate, bis(1,4-epoxypropyl) terephthalate, bis(2,3-epoxypropyl) adipate, dimer acid glycidyl ester having at least two glycidyloxycarbonyl groups, polyacrylate having at least two glycidyloxycarbonyl groups, polymethacrylate having at least two glycidyloxycarbonyl groups or a combination thereof.

According to embodiments of the disclosure, the epoxy compound of the disclosure may be a reaction product of compound (I) and compound (II), wherein compound (I) may react with compound (II) in the presence of an initiator. According to embodiments of the disclosure, the epoxy compound of the disclosure may be a product of compound (I) and compound (II) via a radical polymerization. According to embodiments of the disclosure, compound (I) may be glycidyl methacrylate, glycidyl acrylate, or a combination thereof. According to embodiments of the disclosure, compound (II) is polyethylene glycol dimethacrylate, polypropylene glycol dimethacrylate, polyethylene glycol diacrylate, polypropylene glycol diacrylate, dipropylene glycol diacrylate (DPGDA), ethoxylated bisphenol-A dimethacrylate, ethoxylated bisphenol-A diacrylate, tricyclodecane dimethanol diacrylate, propoxylated neopentyl glycol diacrylate, tripropylene glycol diacrylate, or a combination thereof.

According to embodiments of the disclosure, when the epoxy compound of the disclosure is an oligomer or a polymer (i.e. having at least two repeating units or more than two repeating units), the weight average molecular weight of the oligomer or the polymer may be 700 g/mol to 200,000 g/mol, such as about 1,000 g/mol to 180,000 g/mol, 1,000 g/mol to 150,000 g/mol, 1,000 g/mol to 120,000 g/mol 1, 1,000 g/mol to 100,000 g/mol, 1,500 g/mol to 100,000 g/mol, 2,000 g/mol to 100,000 g/mol, 3,000 g/mol to 100,000 g/mol, or 5,000 g/mol to 100,000 g/mol. The weight average molecular weight (Mw) of the disclosure can be determined by gel permeation chromatography (GPC) based on a polystyrene calibration curve.

According to embodiments of the disclosure, the first metal particle may have a particle size distribution D90 less than or equal to about 1 μm, such as about 0.1 μm to 1 μm, 0.1 μm to 0.9 μm, 0.1 μm to 0.8 μm, 0.1 μm to 0.75 μm, or 0.1 μm to 0.7 μm. When the first metal particle of the conductive composition has a particle size distribution D90 that is less than or equal to about 1 m, the first metal particle can coordinate with the epoxy compound of the composition, thereby causing a blue shift in the carbonyl signal of the epoxy compound. Conversely, when the first metal particle of the conductive composition has a particle size distribution D90 that is greater than about 1 m (such as greater than about 1.5 m, greater than 1.8 m, or greater than 2 m), the first metal particle does not coordinate with the epoxy compound of the composition, and there is no blue shift in the carbonyl signal of the epoxy compound (even a red shift in the carbonyl signal of the epoxy compound may occur).

According to embodiments of the disclosure, the first metal particle can include a first metal core and a first modified layer, wherein the first modified layer covers (or encapsulates) the first metal core. According to embodiments of the disclosure, the first metal particle may consist of a first metal core and a first modified layer, wherein the first modified layer covers (or encapsulates) the first metal core.

According to embodiments of the disclosure, the weight ratio of the first modified layer to the first metal core may be about 0.1:99.9 to 2:98, such as about 0.2:99.8, 0.3:99.7, 0.5:99.5, 0.7:99.3, 0.8:99.2, 1:99, or 1.5:98.5.

According to embodiments of the disclosure, the first metal core may consist of a metal element, wherein the metal element may be silver, copper, gold, aluminum, platinum, nickel, palladium, tin, indium, or bismuth. According to embodiments of the disclosure, the first metal core may be silver, copper, gold, aluminum, platinum, nickel, palladium, tin, indium, bismuth, or a combination thereof (or an alloy thereof).

According to embodiments of the disclosure, the first modified layer may be derived from a first modifier, wherein the modifier may be C₆₋₂₀ carboxylic acid, C₆₋₂₀ primary amine, or a combination thereof. According to embodiments of the disclosure, the first modifier may be caproic acid, palmitic acid, stearic acid, oleic acid, butylamine, octylamine, oleylamine, or a combination thereof.

According to embodiments of the disclosure, the residual percentage at 200° C. of the first modified layer of the first metal particle may be less than or equal to about 0.35%, such as about 0.01% to 0.35%, 0.02% to 0.35%, 0.05% to 0.35%, 0.08% to 0.35%, 0.1% to 0.35%, 0.15% to 0.35%, or 0.01% to 0.3%. When the residual percentage at 200° C. of the first modified layer in the first metal particle is too high, the sintering properties of metal particle would be deteriorated (the metal particles still remain in the form of a particle after sintering process). Even if the epoxy compound of the conductive composition can coordinate with the metal particle (i.e. causing a blue shift in the carbonyl signal of the epoxy compound), the conductivity coefficient and shear strength of the obtained conductive layer could not be effectively improved.

According to embodiments of the disclosure, when the conductive composition of the disclosure includes the first metal particle (i.e. the metal particle having a particle size distribution D90 less than or equal to about 1 m), the conductive composition of the disclosure may further include a metal particle having a particle size distribution D90 greater than about 1 μm. According to embodiments of the disclosure, the component (B) of the conductive composition of the disclosure can further include a second metal particle, wherein the second metal particle has a particle size distribution D90 that is greater than about 1 μm and less than 10 μm, such as about 1.5 μm, 2 μm, 3 μm, 4 μm, 5 μm, 6 μm, 7 μm, 8 μm, or 9 μm. According to embodiments of the disclosure, in the component (B), the weight ratio of the first metal particle to the second metal particle may be about 70:30 to 99:1, such as about 75:25, 80:20, 85:15, 90:10, or 95:5. When the amount of the second metal particle is too high, the amount of metal particle, which does not coordinate with the epoxy compound (i.e. the second metal particle), in the conductive composition is increased, resulting in an obvious reduction in the conductivity coefficient and shear strength of the conductive layer that is obtained.

According to embodiments of the disclosure, the second metal particle can include a second metal core and a second modified layer, wherein the second modified layer covers (or encapsulates) the second metal core. According to embodiments of the disclosure, the second metal particle may consist of a second metal core and a second modified layer, wherein the second modified layer covers (or encapsulates) the second metal core.

According to embodiments of the disclosure, the weight ratio of the second modified layer to the second metal core may be about 0.1:99.9 to 2:98, such as about 0.2:99.8, 0.3:99.7, 0.5:99.5, 0.7:99.3, 0.8:99.2, 1:99, or 1.5:98.5.

According to embodiments of the disclosure, the second metal core may consist of a metal element, wherein the metal element may be silver, copper, gold, aluminum, platinum, nickel, palladium, tin, indium, or bismuth. The material of the second metal core is not an alloy. According to embodiments of the disclosure, the second metal core may be silver, copper, gold, aluminum, platinum, nickel, palladium, tin, indium, bismuth, or a combination thereof (or an alloy thereof).

According to embodiments of the disclosure, the second modified layer may be derived from a second modifier, wherein the modifier may be C₆₋₂₀ carboxylic acid, C₆₋₂₀ primary amine, or a combination thereof. According to embodiments of the disclosure, the second modifier may be caproic acid, palmitic acid, stearic acid, oleic acid, butylamine, octylamine, oleylamine, or a combination thereof.

According to embodiments of the disclosure, the residual percentage at 200° C. of the second modified layer of the second metal particle may be less than or equal to about 0.35%, such as about 0.01% to 0.35%, 0.02% to 0.35%, 0.05% to 0.35%, 0.08% to 0.35%, 0.1% to 0.35%, 0.15% to 0.35%, or 0.01% to 0.3%.

According to embodiments of the disclosure, the first metal particle and the second metal particle can be independently flaky shaped, ball shaped, bar shaped, or a combination thereof.

According to embodiments of the disclosure, the conductive composition can further include 0.1 to 5 parts by weight (such as 0.5 parts by weight, 1 part by weight, 2 parts by weight, 3 parts by weight, or 4 parts by weight) of a component (C), wherein the component (C) is an initiator. According to embodiments of the disclosure, the conductive composition of the disclosure may consist of the component (A), component (B) and component (C). According to embodiments of the disclosure, the component (A) is the compound having at least one glycidyl oxycarbonyl group, the component (B) is the first metal particle, and the component (C) is the initiator. According to embodiments of the disclosure, the component (A) is the compound having at least one glycidyloxycarbonyl group, the component (B) is the first metal particle and the second metal particle, and the component (C) is the initiator.

According to embodiments of the disclosure, the initiator of the disclosure may be iodonium salt, sulfonium salt, diazonium salt, selenonium salt, pyridinium salt, ferrocenium salt, phosphonium salt, sulfonate, or a combination thereof.

According to embodiments of the disclosure, the initiator may be iodonium salt, such as 4-isopropyl-4′-methyldiphenyliodonium tetrakis (pentafluorophenyl) borate, (tricumyl)iodonum tetrakis(pentafluorophenyl)borate, diphenyliodonium hexafluorophosphate, diphenyliodonium hexafluoroantimonate, diphenyliodonium tetrafluoroborate, diphenyliodonium tetrakis(pentafluorophenyl)borate, bis(dodecylphenyl)iodonium hexafluorophosphate, bis(dodecylphenyl)iodonium hexafluoroantimonate, bis(dodecylphenyl)iodonium tetrafluoroborate, bis(dodecylphenyl)iodonium tetrakis(pentafluorophenyl)borate, 4-methylphenyl-4-(1-methylethyl)phenyliodonium hexafluorophosphate, 4-methylphenyl-4-(1-methylethyl)phenyliodonium hexafluoroantimonate, 4-methylphenyl-4-(1-methylethyl)phenyliodonium tetrafluoroborate, 4-methylphenyl-4-(1-methylethyl)phenyliodonium tetrakis(pentafluorophenyl)borate, or a combination thereof. According to embodiments of the disclosure, the iodonium salt of the disclosure may be commercially available, such as UV-9380C (commercially available from GE Toshiba Silicones Co., Ltd.), WPI-016, WPI-116, and WPI-113 (commercially available from Wako Pure Chemical Industries, Ltd.).

According to embodiments of the disclosure, the initiator may be sulfonium salt, such as bis[4-(diphenylsulfonio)phenyl]sulfide bishexafluorophosphate, bis[4-(diphenylsulfonio)phenyl]sulfide bishexafluoroantimonate, bis[4-(diphenylsulfonio)phenyl]sulfide bistetrafluoroborate, bis[4-(diphenylsulfonio)phenyl]sulfide tetrakis(pentafluorophenyl)borate, diphenyl-4-(phenylthio)phenylsulfonium hexafluorophosphate, diphenyl-4-(phenylthio)phenylsulfonium hexafluoroantimonate, diphenyl-4-(phenylthio)phenylsulfonium tetrafluoroborate, diphenyl-4-(phenylthio)phenylsulfonium tetrakis(pentafluorophenyl)borate, triphenylsulfonium hexafluorophosphate, triphenylsulfonium hexafluoroantimonate, triphenylsulfonium tetrafluoroborate, triphenylsulfonium tetrakis(pentafluorophenyl)borate, bis[4-(di(4-(2-hydroxyethoxy))phenylsulfonio)phenyl]sulfide bishexafluorophosphate, bis[4-(di(4-(2-hydroxyethoxy))phenylsulfonio)phenyl]sulfide bishexafluoroantimonate, bis[4-(di(4-(2-hydroxyethoxy))phenylsulfonio)phenyl]sulfide bistetrafluoroborate, bis[4-(di(4-(2-hydroxyethoxy))phenylsulfonio)phenyl]sulfide tetrakis(pentafluorophenyl)borate, or a combination thereof. According to embodiments of the disclosure, the sulfonium salt of the disclosure may be commercially available, such as CYRACURE UVI-6990, CYRACURE UVI-6992, CYRACURE UVI-6974 (commercially available from Dow Chemical Japan Limited), ADEKA OPTOMER SP-150, ADEKA OPTOMER SP-152, ADEKA OPTOMER SP-170, ADEKA OPTOMER SP-172 (commercially available from ADEKA CORPORATION), WPAG-593, WPAG-596, WPAG-640, and WPAG-641 (commercially available from Wako Pure Chemical Industries, Ltd.).

According to embodiments of the disclosure, the initiator may be diazonium salt, such as benzenediazonium hexafluoroantimonate, benzenediazonium hexafluorophosphate, benzenediazonium hexafluoroborate, or a combination thereof.

According to embodiments of the disclosure, the initiator may be selenonium salt, such as triphenylselenonium tetrafluoroborate, triphenylselenonium hexafluoroarsenate, triphenylselenonium fluoroantimonate, p-(t-butylphenyl)diphenylselenonium hexafluoroarsenate, or a combination thereof.

According to embodiments of the disclosure, the initiator may be phosphonium salt, such as ethyltriphenylphosphonium antimony hexafluoride, tetrabutylphosphonium antimony hexafluoride, or a combination thereof.

According to embodiments of the disclosure, a conductive adhesive layer of the conductive composition of the disclosure may be formed by a coating process, printing process, or dispensing process.

The conductive composition of the disclosure can further include 1 to 5 parts by weight (such as 2 parts by weight, 3 parts by weight, or 4 parts by weight) of a component (D), wherein the component (D) is a solvent. The coating process may be screen printing, spin coating, bar coating, blade coating, roller coating, solvent casting or dip coating. When the amount of component (D) in the conductive composition of the disclosure is too high, the obtained layer may have void defects due to excessive solvent evaporation in the subsequent sintering process. According to embodiments of the disclosure, the conductive composition of the disclosure may consist of the component (A), component (B), component (C), and component (D). According to embodiments of the disclosure, the solvent may be water, diethylene glycol diethyl ether, diethylene glycol dimethyl ether, propylene glycol methyl ether acetate, diethylene glycol butyl ether acetate, ethylene glycol butyl ether, tetraethylene glycol dimethyl ether, tri(propylene glycol) methyl ether, texanol (2,2,4-trimethyl-1,3-pentanediol monoisobutyrate), hexyl acetate, 2-ethyl-1,3-hexanediol or a combination thereof.

According to embodiments of the disclosure, the disclosure also provides a conductive layer. According to embodiments of the disclosure, the conductive layer can include a product of the conductive composition of the disclosure via a sintering process (including a baking process). According to embodiments of the disclosure, the conductive layer may be a product of the conductive composition of the disclosure via a sintering process. According to embodiments of the disclosure, the sintering process may be performed under atmospheric pressure (1 atm), and the sintering process has a process temperature of about 180° C. to 220° C., such as about 190° C., 200° C., or 210° C. Namely, the conductive composition of the disclosure may be baked at a relatively low temperature to form the conductive layer, and the conductive composition of the disclosure may form the conductive layer in the sintering process without pressurization.

According to embodiments of the disclosure, the sintering process time period may be about 30 minutes to 12 hours, such as about 1 hour, 2 hours, 3 hours, 4 hours, 5 hours, 6 hours, 7 hours, 8 hours, 9 hours, 10 hours, or 11 hours. In addition, before performing the sintering process, the coating of the conductive composition of the disclosure may be subjected to a prebaking process to remove the solvent in the coating.

According to embodiments of the disclosure, the prebaking process may have a process temperature of about 70° C. to 120° C., such as 80° C., 90° C., 100° C., or 110° C., the process time period of the prebaking process may be 5 minutes to 2 hours, such as about 10 minutes, 30 minutes, 1 hour, or 1.5 hours.

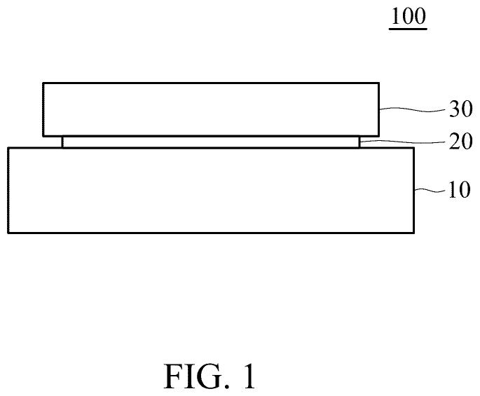

According to embodiments of the disclosure, the disclosure also provides an electronic device. FIG. 1 is a cross-sectional view of the electronic device 100 according to embodiments of the disclosure, wherein the electronic device 100 includes a substrate 10 and a conductive layer 20 disposed on substrate 10, wherein the conductive layer may be a product of the conductive composition of the disclosure via sintering process. According to embodiments of the disclosure, the electronic device 100 may further include an electronic element 30, and the conductive layer 20 is disposed between the substrate 10 and the electronic element 30. Namely, the electronic element 30 is bonded on the substrate 10 via the conductive layer 20 to establish an electrical connection between the electronic element 30 and substrate 10. According to embodiments of the disclosure, any required electronic element (such as an electrode) can be formed on the substrate. The accompanying drawings illustrate the substrate as a plain rectangle in order to simplify the illustration. According to embodiments of the disclosure, the electronic element 30 is not limited and can be optionally modified by a person of ordinary skill in the field, such as a semiconductor chip, touch panel, display component, diode, solar component, or organic light-emitting diode.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLE

### Metal Particle

### Preparation Example 1

Vitamin C (38.4 parts by weight) was dissolved in propylene glycol methyl ether (PGME) (1497 parts by weight) at 70° C., and a first solution was obtained after cooling. Silver nitrate (44.8 parts by weight) was dissolved in propylene glycol methyl ether (PGME) (440 parts by weight), and then n-octylamine (250 parts by weight) was added after stirring. After stirring, a second solution was obtained and stood until it cooled to room temperature. Next, the first solution was rapidly added into the second solution. After stirring for 30 minutes, the result was subjected to a centrifugal washing with propylene glycol methyl ether (PGME) (with a centrifugation speed of 2000 rpm and a time period of 30 minutes), obtaining Metal particle (1) (with a residual n-octylamine modified layer thereon) (having a particle size distribution D90 of about 0.7 μm).

### Preparation Example 2

Silver particle (with a trade number of LS0305@PA01 commercially available from TOKUSEN KOGYO CO., LTD) (with a palmitic acid modified layer thereon), was subjected to a centrifugal washing with propylene glycol methyl ether (PGME) (with a centrifugation speed of 2000 rpm and a time period of 30 minutes), obtaining Metal particle (2).

### Preparation Example 3

Silver particle (with a trade number of LS0305@HA05 commercially available from TOKUSEN KOGYO CO., LTD) (with a caproic acid modified layer thereon), was subjected to a centrifugal washing with propylene glycol methyl ether (PGME) (with a centrifugation speed of 2000 rpm and a time period of 30 minutes), obtaining Metal particle (3).

### Residual Percentage Analysis of Modified Layer on the Metal Particle

The residual percentage of the modified layer on Metal particles (1)-(3) and various commercially available silver particles were determined at 200° C., and the results are shown in Table 1.

The method for determining the residual percentage of the modified layer on the surface of metal particles at 200° C. included the following steps.

50 mg of metal particle was placed on a platinum plate for thermal gravimetric analysis. At ambient atmosphere, the platinum plate was heated to 800° C. with a heating rate of 20° C./min, and the percentage of weight loss at 200° C. (W1) and the percentage of weight loss at 800° C. (W2) were measured. The percentage of weight loss at 800° C. (W2) represents the overall coverage rate of the modified layer on the surface of the metal particle. The percentage of weight loss at 200° C. (W1) represents the loss rate of the modified layer decomposed at 200° C. Therefore, the residual percentage (R) of the modified layer on the surface of metal particle at 200° C. was represented by W2−W1.

TABLE 1

| | | | | the residual |
|---|---|---|---|---|
| | | | | percentage (R) of |
| | | particle size | | the modified layer |
| metal particle | source | distribution | modified layer | at 200° C. (%) |
| LS0305@WA | TOKUSEN | D10 = ~0.14 μm | organic | 0.14 |
| | KOGYO CO., | D50 = ~0.24 μm | surfactant | |
| LS0305@PA01 | LTD | D90 = ~0.51 μm | palmitic acid | 0.44 |
| LS0305@HA05 | | | caproic acid | 0.39 |
| LS0305@SA05 | | | stearic acid | 0.75 |
| Metal particle (1) | in-house | D90 = ~0.7 μm | n-octylamine | 0.19 |
| | preparation | | | |
| Metal particle (2) | in-house | D10 = ~0.14 μm | palmitic acid | 0.14 |
| | preparation | D50 = ~0.24 μm | | |
| Metal particle (3) | in-house | D90 = ~0.51 μm | caproic acid | 0.28 |
| | preparation | | | |

Herein, the particle size distribution D90 means that 90 vol % of the powder has a diameter less than the value defined by D90. The particle size distribution D50 means that 50 vol % of the powder has a diameter less than the value defined by D50. The particle size distribution D10 means that 10 vol % of the powder has a diameter less than the value defined by D10. According to embodiments of the disclosure, the particle size distribution is measured according to the standard ISO 13322-1:2004.

### Sintering Evaluation of Metal Particle

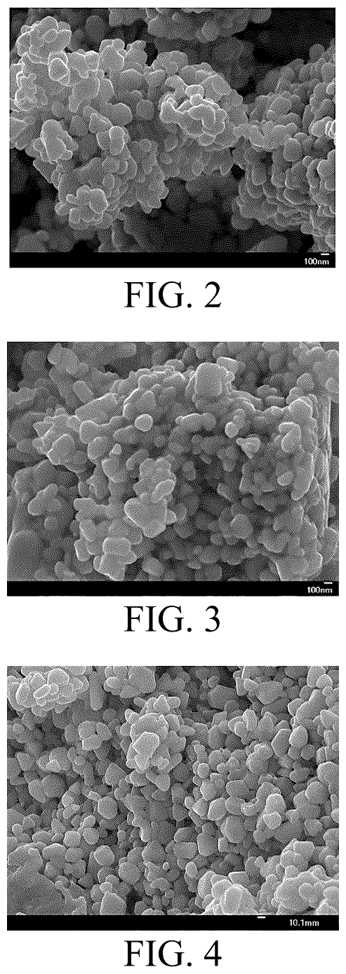

The silver particle (with a trade number of LS0305@PA01 commercially available from TOKUSEN KOGYO CO., LTD) (with a palmitic acid modified layer thereon) was observed by field emission scanning electron microscope (FESEM) (JEOL JSM-6500F), and the result is shown in FIG. 2. Next, 95 parts by weight of silver particle (LS0305@PA01) and 5 parts by weight of glycidyl ester epoxy compound (with a structure represented by

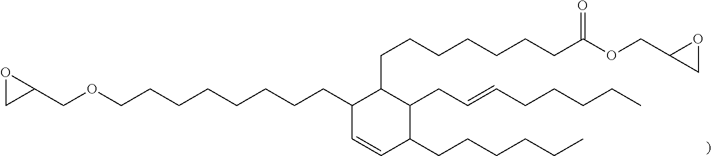 [SMILES: CCCCC/C=C/CC1C(CCCCCC)C=CC(CCCCCCCCOCC2CO2)C1CCCCCCCC(=O)OCC1CO1]

(with a trade number of jER871, commercially available from Mitsubishi Chemicals Corp) were mixed by planetary centrifugal mixer and then dispersed by a three-roll mill. Next, the result was baked at 200° C. for 1 hour. The sintering result was cooled to room temperature and then glycidyl ester epoxy compound (or derivatives thereof) was removed. The sintered metal particle was observed by field emission scanning electron microscope (FESEM), and the result is shown in FIG. 3. As shown in FIG. 2, FIG. 3 and Table 1, the commercially available silver particle (LS0305@PA01) had a residual percentage of a modified layer at 200° C. greater than 0.4% (as shown in Table 1). The profile of sintered silver particle (mixed with glycidyl ester epoxy compound) is similar to the profile of the silver particle before sintering. No sintering combination of the sintered metal particles is observed.

Next, Metal particle (2) (prepared by subjecting silver particle with the trade number LS0305@PA01 to centrifugation and PGME washing) was observed by field emission scanning electron microscope (FESEM) (JEOL JSM-6500F), and the result is shown in FIG. 4. Next, 95 parts by weight of Metal particle (2) and 5 parts by weight of glycidyl ester epoxy compound (jER871) were mixed by planetary centrifugal mixer and then dispersed by a three-roll mill. Next, the result was baked at 200° C. for 1 hour. The sintering result was cooled to room temperature and then glycidyl ester epoxy compound (or derivatives thereof) was removed. The sintered metal particle was observed by field emission scanning electron microscope (FESEM), and the result is shown in FIG. 5. As shown in FIG. 4, FIG. 5 and Table 1, Metal particle (2) had a residual percentage of a modified layer at 200° C. of 0.14% (as shown in Table 1). After mixing with glycidyl ester epoxy compound and sintering, an obvious sintering combination of metal particles is observed.

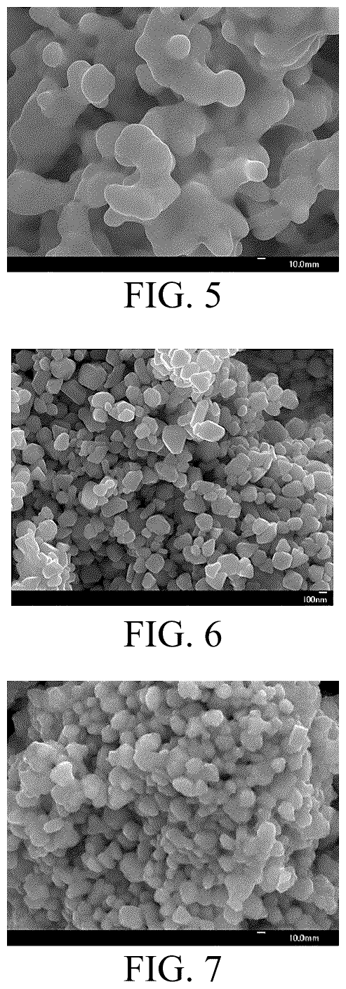

The silver particle (with a trade number of LS0305@HA05, commercially available from TOKUSEN KOGYO CO., LTD) (with a caproic acid modified layer thereon) was observed by field emission scanning electron microscope (FESEM) (JEOL JSM-6500F), and the result is shown in FIG. 6. Next, 95 parts by weight of silver particle (LS0305@HA05) and 5 parts by weight of glycidyl ester epoxy compound (jER871) were mixed by planetary centrifugal mixer and then dispersed by a three-roll mill. Next, the result was baked at 200° C. for 1 hour. The sintering result was cooled to room temperature and then glycidyl ester epoxy compound (or derivatives thereof) was removed. The sintered metal particle was observed by field emission scanning electron microscope (FESEM), and the result is shown in FIG. 7. As shown in Table 1, the commercially available silver particle (with a trade number of LS0305@HA05) had a residual percentage of a modified layer at 200° C. of 0.39%. As shown in FIG. 6 and FIG. 7, after mixing with glycidyl ester epoxy compound and sintering, the profile of the metal particle remains in the form of a particle.

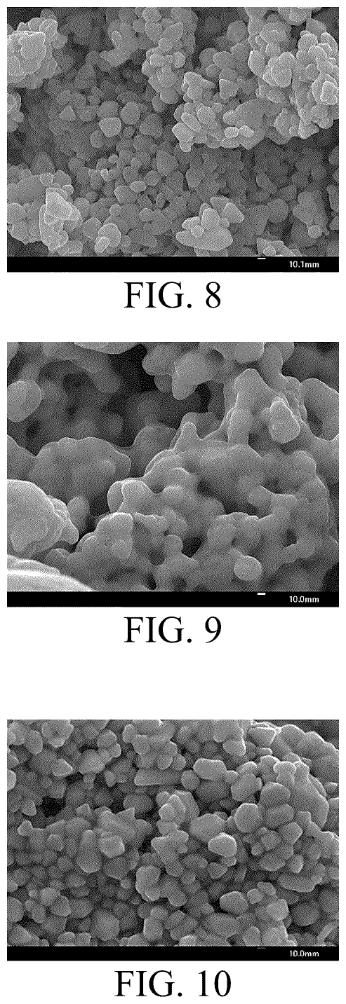

Next, Metal particle (3) (prepared by subjecting silver particle with the trade number of LS0305@HA05 to centrifugation and PGME washing) was observed by field emission scanning electron microscope (FESEM) (JEOL JSM-6500F), and the result is shown in FIG. 8. Next, 95 parts by weight of Metal particle (3) and 5 parts by weight of glycidyl ester epoxy compound (jER871) were mixed by planetary centrifugal mixer and then dispersed by a three-roll mill. Next, the result was baked at 200° C. for 1 hour. The sintering result was cooled to room temperature and then glycidyl ester epoxy compound (or derivatives thereof) was removed. The sintered metal particle was observed by field emission scanning electron microscope (FESEM), and the result is shown in FIG. 9. As shown in FIG. 8 and FIG. 9, Metal particle (3) had a residual percentage of a modified layer at 200° C. of 0.28% (as shown in Table 1). After mixing with glycidyl ester epoxy compound and sintering, an obvious sintering combination of metal particles is observed. Accordingly, when the residual percentage of a modified layer at 200° C. of the metal particle is further reduced (such as less than or equal to 0.35%), the sintering properties of the metal particle would be improved (i.e. enhancing the sintering combination of metal particles).

95 parts by weight of silver particle (LS0305@SA05) and 5 parts by weight of glycidyl ester epoxy compound (jER871) were mixed by planetary centrifugal mixer and then dispersed by a three-roll mill. Next, the result was baked at 200° C. for 1 hour. The sintering result was cooled to room temperature and then glycidyl ester epoxy compound (or derivatives thereof) was removed. The sintered metal particle was observed by field emission scanning electron microscope (FESEM) as shown in FIG. 10. In FIGS. 3, 7 and 10, the commercially available metal particle had a relatively high residual percentage of the modified layer at 200° C. (greater than or equal to 0.4%). Therefore, the sintering properties of the metal particle would not be improved (remaining in the form of a particle).

As shown in Table 2, various combinations of metal particles (95 parts by weight) and epoxy compounds (5 parts by weight) were prepared by mixing by planetary centrifugal mixer and dispersing by a three-roll mill. The carbonyl (C═O) characteristic peak (at 1670 cm⁻¹ to 1780 cm⁻¹) of the results of combinations were observed by Fourier-transform infrared spectroscopy (FT-IR) (with a resolution of 4). The carbonyl signal shift was determined by comparing the carbonyl signal of epoxy compound, and the results are shown in Table 2.

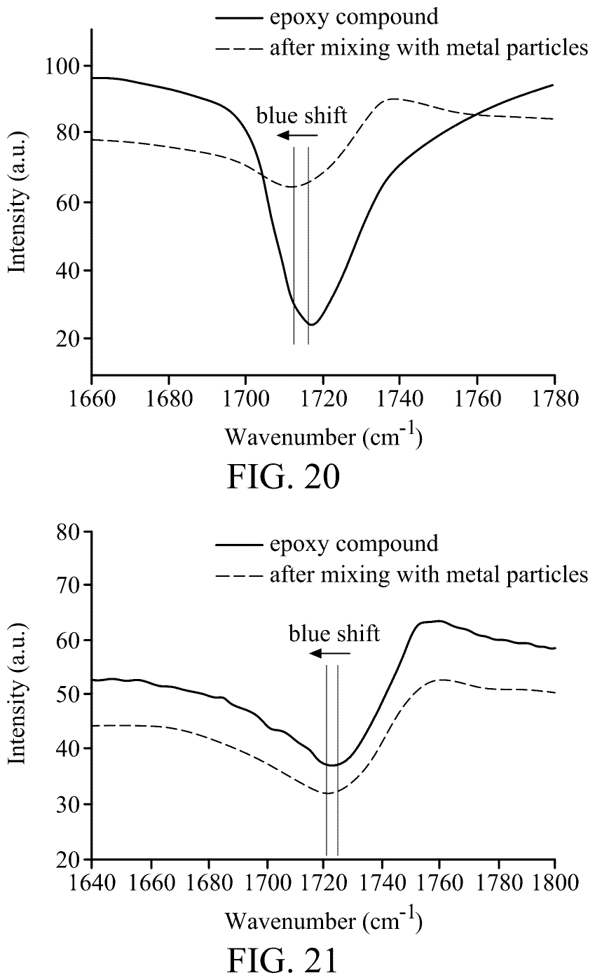

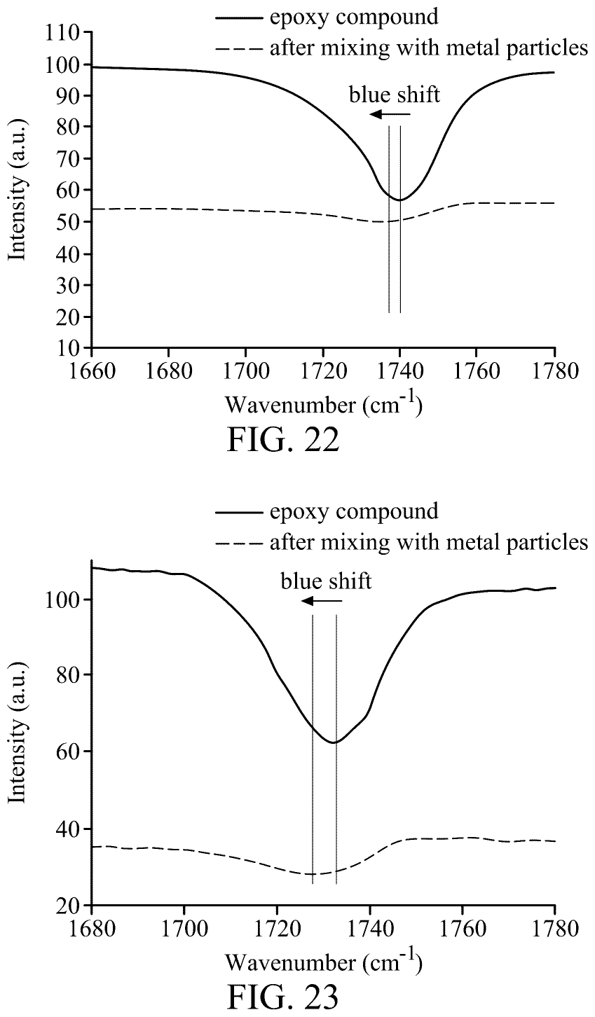

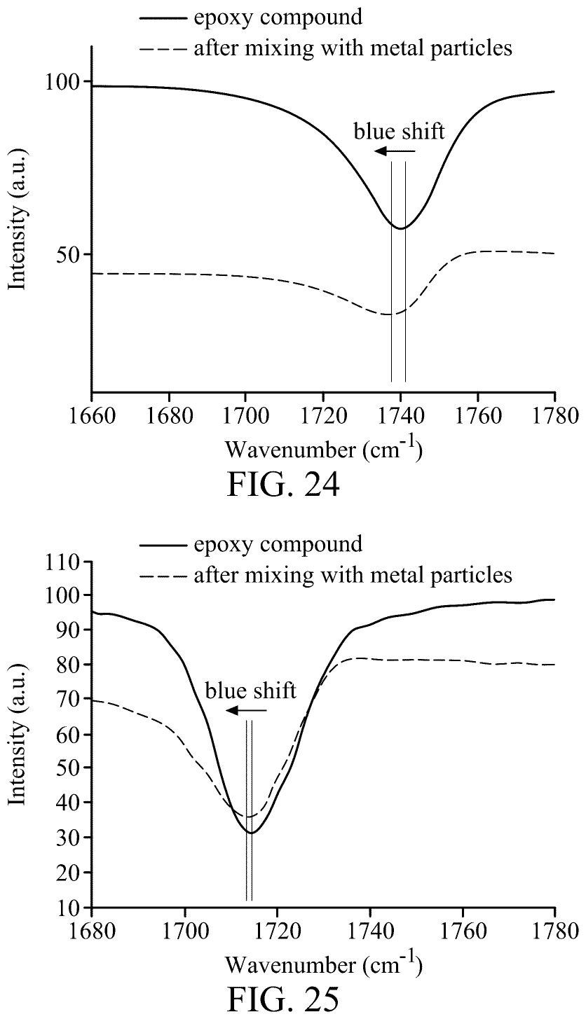

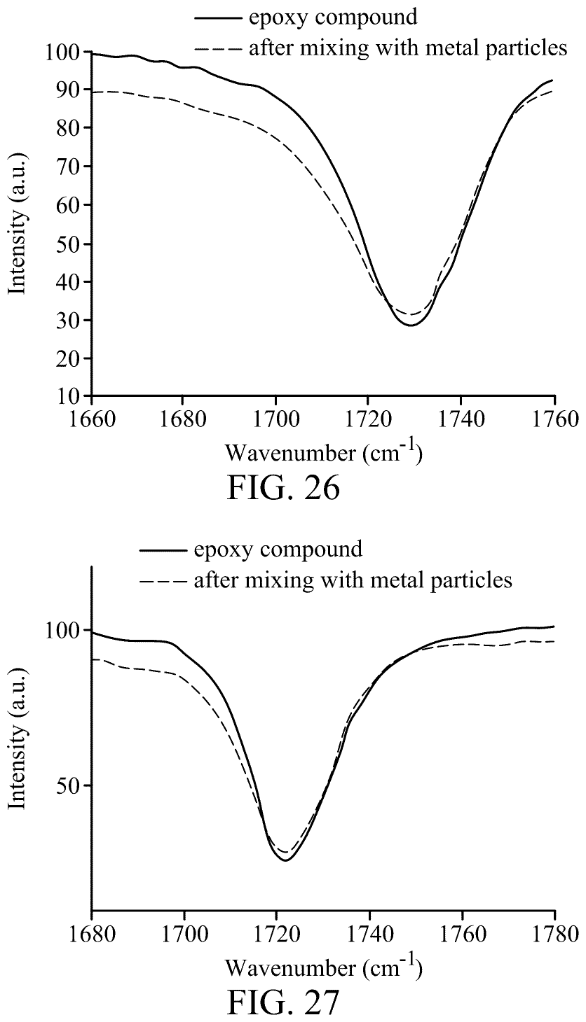

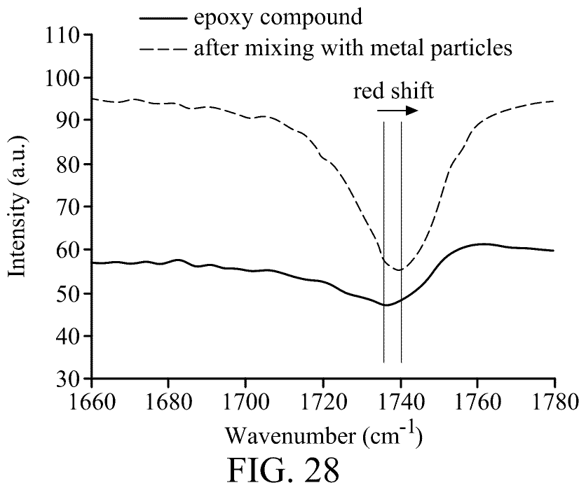

TABLE 2

| combination | epoxy compound | metal particle | carbonyl signal shift |
|---|---|---|---|
| (1) | glycidyl methacrylate | LS0305@WA | blue shift in the carbonyl |
| | | | signal (shifting from 1716 |
| | | | cm⁻¹ to 1713 cm⁻¹)(as shown |
| | | | in FIG. 20) |
| (2) | diglycidyl 1,2- | LS0305@WA | blue shift in the carbonyl |
| | cyclohexane dicarboxylate | | signal (shifting from 1724 |
| | | | cm⁻¹ to 1721 cm⁻¹) |
| | | | (as shown in FIG. 21) |
| (3) | glycidyl ester epoxy | LS0305@WA | blue shift in the carbonyl |
| | compound (jER871) | | signal (shifting from 1740 |
| | | | cm⁻¹ to 1736 cm⁻¹) |
| | | | (as shown in FIG. 22) |
| (4) | 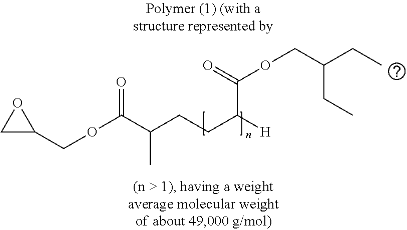 | LS0305@WA | blue shift in the carbonyl signal (shifting from 1732 cm⁻¹ to 1727 cm⁻¹) (as shown in FIG. 23) |
| (5) | glycidyl ester epoxy | Metal particle (1) | blue shift in the carbonyl |
| | compound (jER871) | | signal (shifting from 1740 |
| | | | cm⁻¹ to 1737 cm⁻¹) |
| | | | (as shown in FIG. 24) |
| (6) | 3,4- | LS0305@WA | blue shift in the carbonyl |
| | epoxycyclohexylmethyl | | signal (shifting from 1714 |
| | methacrylate | | cm⁻¹ to 1713 cm⁻¹) |
| | | | (as shown in FIG. 25) |
| (7) | bis(3,4- | LS0305@WA | no shift in the carbonyl signal |
| | epoxycyclohexylmethyl) | | (as shown in FIG. 26) |
| | adipate | | |
| (8) | 1,10-decanediol diacrylate | LS0305@WA | no shift in the carbonyl signal |
| | | | (as shown in FIG. 27) |
| (9) | glycidyl ester epoxy | SI11000-10 | red shift in the carbonyl |
| | compound (jER871) | | signal (shifting from 1736 |
| | | | cm⁻¹ to 1740 cm⁻¹) |
| | | | (as shown in FIG. 28) |

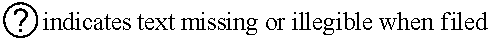

As shown in Table 2, in the combinations (1)-(5), since the specific epoxy compound of the disclosure was mixed with the specific metal particle of the disclosure (having a particle size distribution D90 less than 1l m and a residual percentage of modified layer at 200° C. less than or equal to 0.35%), the blue shift (cm⁻¹) in the carbonyl signal of the epoxy compound in the mixture was greater than or equal to 3 cm⁻¹.

This means that a coordination between the specific metal particle of the disclosure and the epoxy compound of the disclosure could be formed. In addition, in the combination (6), since 3,4-epoxycyclohexylmethylmethacrylate served as epoxy compound, the blue shift (cm⁻¹) in the carbonyl signal of the epoxy compound in the mixture was not obvious (blue shift was 1 cm⁻¹). In the combinations (7) and (8), bis(3,4-epoxycyclohexylmethyl) adipate and 1,10-decanediol diacrylate served as the epoxy compound respectively. Since there is no blue shift in the carbonyl signal of the epoxy compound in the combinations (7) and (8), a coordination between the epoxy compound and the metal particle could not be formed.

Furthermore, in the combination (9), the silver particle (with a trade number of SI11000-10, commercially available from Ferro Japan) (having a residual percentage of modified layer at 200° C. of 0.057%) (D10=˜1 μm, D50=˜1.25 μm, D90=˜2.25 μm) has a particle size distribution D10 of about 1 m (i.e. most of the particles have a diameter greater than 1 μm). Therefore, a red shift in the carbonyl signal of glycidyl ester epoxy compound (jER871) in the combination (9) was observed. This means that no coordination between the epoxy compound and the metal particle was formed due to the larger metal particle size.

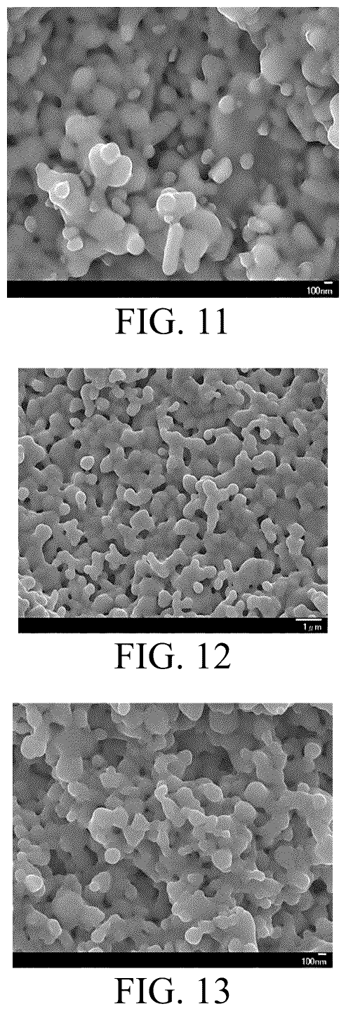

After baking the combinations (1)-(5) at 200° C. for 1 hour, the sintering results were cooled to room temperature. Next, after removing the epoxy compound (or derivatives thereof) of the sintering results, the sintered metal particle was observed by field emission scanning electron microscope (FESEM), as shown in FIGS. 11-15. As shown in FIGS. 11-15, after sintering, a sintering combination in the residual metal particles of the combinations (1)-(5) was observed.

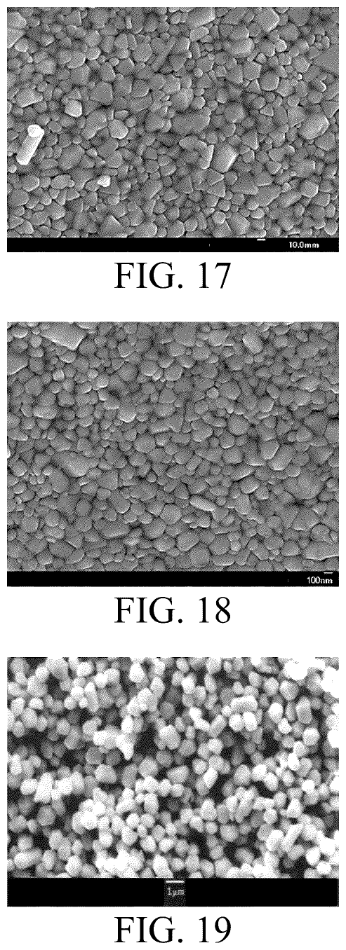

After baking the combinations (6)-(8) at 200° C. for 1 hour, the sintering results were cooled to room temperature. Next, after removing the epoxy compound (or derivatives thereof) of the sintering results, the sintered metal particle was observed by field emission scanning electron microscope (FESEM), as shown in FIGS. 16-18.

As shown in FIGS. 16-18, the residual metal particle of the combinations (6)-(8) still remains in the form of a particle after sintering process. Namely, no sintering combination in the residual metal particles of the combinations (6)-(8) was observed.

After baking the combination (9) at 200° C. for 1 hour, the sintering result was cooled to room temperature. Next, after removing the epoxy compound (or derivatives thereof) of the sintering result, the sintered metal particle was observed by field emission scanning electron microscope (FESEM), as shown in FIG. 19.

As shown in FIG. 19, the residual metal particle of the combination (9) still remains in the form of a particle after sintering process. Namely, no sintering combination in the residual metal particles of the combination (9) was observed. Accordingly, in order to cause sintering combination of metal particles, the specific epoxy compound, which would form coordination with the metal particle, should be selected, and the residual percentage of modified layer at 200° C. of metal particle should be in a specific range.

### Preparation of Conductive Composition

### Example 1

97 parts by weight of silver particle (with a trade number of LS0305@WA, commercially available from TOKUSEN KOGYO CO., LTD) (with an organic surfactant modified layer thereon), 3 parts by weight of glycidyl methacrylate (GMA), 1 part by weight of initiator (4-isopropyl-4′-methyldiphenyliodonium tetrakis (pentafluorophenyl) borate), and 5 parts by weight of solvent (diethylene glycol monobutyl ether acetate) were mixed. Next, the result was mixed by a planetary centrifugal mixer and then dispersed by a three-roll mill, obtaining Conductive composition (1).

### Example 2

Example 2 was performed in the same manner as in Example 1 except that the amount of silver particle was reduced from 97 parts by weight to 95 parts by weight, and the amount of glycidyl methacrylate (GMA) was increased from 3 parts by weight to 5 parts by weight, obtaining Conductive composition (2).

### Example 3

Example 3 was performed in the same manner as in Example 1 except that the amount of silver particle was reduced from 97 parts by weight to 93 parts by weight, and the amount of glycidyl methacrylate (GMA) was increased from 3 parts by weight to 7 parts by weight, obtaining Conductive composition (3).

### Example 4

Example 4 was performed in the same manner as in Example 1 except that the silver particle (LS0305@WA) was replaced with Metal particle (1) of Preparation Example 1, obtaining Conductive composition (4).

### Example 5

Example 5 was performed in the same manner as in Example 4 except that the amount of Metal particle (1) was reduced from 97 parts by weight to 95 parts by weight, and the amount of glycidyl methacrylate (GMA) was increased from 3 parts by weight to 5 parts by weight, obtaining Conductive composition (5).

### Example 6

Example 6 was performed in the same manner as in Example 4 except that the amount of Metal particle (1) was reduced from 97 parts by weight to 93 parts by weight, and the amount of glycidyl methacrylate (GMA) was increased from 3 parts by weight to 7 parts by weight, obtaining Conductive composition (6).

### Example 7

Example 7 was performed in the same manner as in Example 1 except that glycidyl methacrylate (GMA) was replaced with diglycidyl 1,2-cyclohexane dicarboxylate (with a trade number of EPALLOY 5200), obtaining Conductive composition (7).

### Example 8

Example 8 was performed in the same manner as in Example 7 except that the amount of silver particle was reduced from 97 parts by weight to 95 parts by weight, and the amount of diglycidyl 1,2-cyclohexane dicarboxylate was increased from 3 parts by weight to 5 parts by weight, obtaining Conductive composition (8).

### Example 9

Example 9 was performed in the same manner as in Example 7 except that the amount of silver particle was reduced from 97 parts by weight to 93 parts by weight, and the amount of diglycidyl 1,2-cyclohexane dicarboxylate was increased from 3 parts by weight to 7 parts by weight, obtaining Conductive composition (9).

### Example 10

Example 10 was performed in the same manner as in Example 7 except that the silver particle (LS0305@WA) was replaced with Metal particle (1) of Preparation Example 1, obtaining Conductive composition (10).

### Example 11

Example 11 was performed in the same manner as in Example 10 except that the amount of Metal particle (1) was reduced from 97 parts by weight to 95 parts by weight, and the amount of diglycidyl 1,2-cyclohexane dicarboxylate was increased from 3 parts by weight to 5 parts by weight, obtaining Conductive composition (11).

### Example 12

Example 12 was performed in the same manner as in Example 10 except that the amount of Metal particle (1) was reduced from 97 parts by weight to 93 parts by weight, and the amount of diglycidyl 1,2-cyclohexane dicarboxylate was increased from 3 parts by weight to 7 parts by weight, obtaining Conductive composition (12).

### Example 13

Example 13 was performed in the same manner as in Example 1 except that glycidyl methacrylate (GMA) was replaced with glycidyl ester epoxy compound (jER871), obtaining Conductive composition (13).

### Example 14

Example 14 was performed in the same manner as in Example 13 except that the amount of silver particle was reduced from 97 parts by weight to 95 parts by weight, and the amount of glycidyl ester epoxy compound (jER871) was increased from 3 parts by weight to 5 parts by weight, obtaining Conductive composition (14).

### Example 15

Example 15 was performed in the same manner as in Example 13 except that the amount of silver particle was reduced from 97 parts by weight to 93 parts by weight, and the amount of glycidyl ester epoxy compound (jER871) was increased from 3 parts by weight to 7 parts by weight, obtaining Conductive composition (15).

### Example 16

Example 16 was performed in the same manner as in Example 13 except that the silver particle (LS0305@WA) was replaced with Metal particle (1) of Preparation Example 1, obtaining Conductive composition (16).

### Example 17

Example 17 was performed in the same manner as in Example 16 except that the amount of Metal particle (1) was reduced from 97 parts by weight to 95 parts by weight, and the amount of glycidyl ester epoxy compound (jER871) was increased from 3 parts by weight to 5 parts by weight, obtaining Conductive composition (17).

### Example 18

Example 18 was performed in the same manner as in Example 16 except that the amount of Metal particle (1) was reduced from 97 parts by weight to 93 parts by weight, and the amount of glycidyl ester epoxy compound (jER871) was increased from 3 parts by weight to 7 parts by weight, obtaining Conductive composition (18).

### Example 19

Example 19 was performed in the same manner as in Example 1 except that glycidyl methacrylate (GMA) was replaced with Polymer (1) (with a structure represented

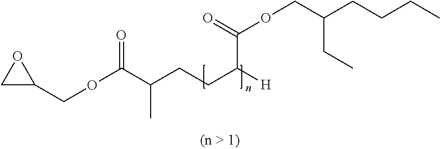

by (n>1) and a weight average molecular weight of about 49,000 g/mol), obtaining Conductive composition (19).

### Example 20

Example 20 was performed in the same manner as in Example 19 except that the amount of silver particle was reduced from 97 parts by weight to 95 parts by weight, and the amount of Polymer (1) was increased from 3 parts by weight to 5 parts by weight, obtaining Conductive composition (20).

### Example 21

Example 21 was performed in the same manner as in Example 19 except that the amount of silver particle was reduced from 97 parts by weight to 93 parts by weight, and the amount of Polymer (1) was increased from 3 parts by weight to 7 parts by weight, obtaining Conductive composition (21).

### Example 22

Example 22 was performed in the same manner as in Example 19 except that the silver particle (LS0305@WA) was replaced with Metal particle (1) of Preparation Example 1, obtaining Conductive composition (22).

### Example 23

Example 23 was performed in the same manner as in Example 22 except that the amount of Metal particle (1) was reduced from 97 parts by weight to 95 parts by weight, and the amount of Polymer (1) was increased from 3 parts by weight to 5 parts by weight, obtaining Conductive composition (23).

### Example 24

Example 24 was performed in the same manner as in Example 22 except that the amount of Metal particle (1) was reduced from 97 parts by weight to 93 parts by weight, and the amount of Polymer (1) was increased from 3 parts by weight to 7 parts by weight, obtaining Conductive composition (24).

### Example 25

Example 25 was performed in the same manner as in Example 2 except that 95 parts by weight of the silver particle (LS0305@WA) was replaced with 66.5 parts by weight of Metal particle (1) and 28.5 parts by weight of silver particle (with a trade number of Ag-2556, commercially available from Ferro Japan) (having a residual percentage of modified layer at 200° C. of 0.32%) (D10=˜1.8 μm, D50=˜2.7 μm, D90=˜4.0 μm), obtaining Conductive composition (25).

### Example 26

Example 26 was performed in the same manner as in Example 8 except that 95 parts by weight of the silver particle (LS0305@WA) was replaced with 66.5 parts by weight of Metal particle (1) and 28.5 parts by weight of silver particle (Ag-2556), obtaining Conductive composition (26).

### Example 27

Example 27 was performed in the same manner as in Example 14 except that 95 parts by weight of the silver particle (LSO305@WA) was replaced with 66.5 parts by weight of Metal particle (1) and 28.5 parts by weight of silver particle (Ag-2556), obtaining Conductive composition (27).

### Example 28

Example 28 was performed in the same manner as in Example 2 except that 95 parts by weight of the silver particle (LS0305@WA) was replaced with 66.5 parts by weight of Metal particle (1) and 28.5 parts by weight of silver particle (with a trade number of SF-70A, commercially available from Ferro Japan) (having a residual percentage of modified layer at 200° C. of 0.33%) (D10=˜1.5 μm, D50=˜3 μm, D90=˜8.5 μm), obtaining Conductive composition (28).

### Example 29

Example 29 was performed in the same manner as in Example 8 except that 95 parts by weight of the silver particle (LS0305@WA) was replaced with 66.5 parts by weight of Metal particle (1) and 28.5 parts by weight of silver particle (SF-70A), obtaining Conductive composition (29).

### Example 30

Example 30 was performed in the same manner as in Example 14 except that 95 parts by weight of the silver particle (LS0305@WA) was replaced with 66.5 parts by weight of Metal particle (1) and 28.5 parts by weight of silver particle (SF-70A), obtaining Conductive composition (30).

### Example 31

Example 31 was performed in the same manner as in Example 23 except that Polymer (1) was replaced with Polymer (2) (with a structure represented by

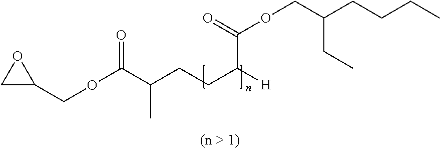

and a weight average molecular weight of about 53,000 g/mol), obtaining Conductive composition (31).

### Example 32

Example 32 was performed in the same manner as in Example 23 except that Polymer (1) was replaced with Polymer (3) (with a structure represented by

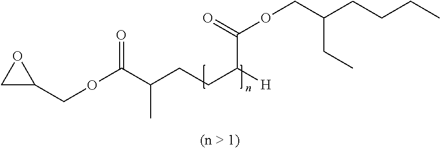

and a weight average molecular weight of about 70,000 g/mol), obtaining Conductive composition (32).

### Example 33

Example 33 was performed in the same manner as in Example 23 except that Polymer (1) was replaced with Polymer (4) (with a structure represented by

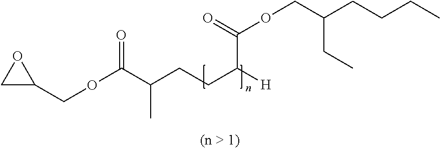

and a weight average molecular weight of about 84,000 g/mol), obtaining Conductive composition (33).

### Comparative Example 1

95 parts by weight of silver particle (LS0305@WA), 5 parts by weight of 3,4-epoxycyclohexylmethyl methacrylate, 1 part by weight of initiator (4-isopropyl-4′-methyldiphenyliodonium tetrakis (pentafluorophenyl) borate), and 5 parts by weight of solvent (diethylene glycol monobutyl ether acetate) were mixed. Next, the result was mixed by a planetary centrifugal mixer and then dispersed by a three-roll mill, obtaining Conductive composition (34).

### Comparative Example 2

Comparative Example 2 was performed in the same manner as in Comparative Example 1 except that 3,4-epoxycyclohexylmethyl methacrylate was replaced with bis(3,4-epoxycyclohexylmethyl) adipate, obtaining Conductive composition (35).

### Comparative Example 3

Comparative Example 3 was performed in the same manner as in Comparative Example 1 except that 3,4-epoxycyclohexylmethyl methacrylate was replaced with 1,10-decanediol diacrylate, obtaining Conductive composition (36).

### Comparative Example 4

Comparative Example 4 was performed in the same manner as in Comparative Example 1 except that 3,4-epoxycyclohexylmethyl methacrylate was replaced with bisphenol A epoxy resin (with a trade number of EPON® Resin 828, commercially available from Shell Chemical), obtaining Conductive composition (37).

### Comparative Example 5

Comparative Example 5 was performed in the same manner as in Example 14 except that the silver particle (LS0305@WA) was replaced with silver particle (LS0305@PA01), obtaining Conductive composition (38).

### Comparative Example 6

Comparative Example 6 was performed in the same manner as in Example 14 except that the silver particle (LS0305@WA) was replaced with silver particle (LS0305@HA05), obtaining Conductive composition (39).

### Comparative Example 7

Comparative Example 7 was performed in the same manner as in Example 14 except that the silver particle (LS0305@WA) was replaced with silver particle (with a trade number of LS0305@SA05, commercially available from TOKUSEN KOGYO CO., LTD) (having a stearic acid modified layer on the surface), obtaining Conductive composition (40).

### Comparative Example 8

Comparative Example 8 was performed in the same manner as in Example 14 except that the silver particle (LS0305@WA) was replaced with silver particle (SI11000-10), obtaining Conductive composition (41).

### Comparative Example 9

Comparative Example 9 was performed in the same manner as in Example 14 except that the amount of silver particle (LS0305@WA) was reduced from 95 parts by weight to 92 parts by weight, and the amount of glycidyl ester epoxy compound (jER871) was increased from 5 parts by weight to 8 parts by weight, obtaining Conductive composition (42).

### Comparative Example 10

Comparative Example 10 was performed in the same manner as in Example 14 except that the amount of silver particle (LS0305@WA) was increased from 95 parts by weight to 98 parts by weight, and the amount of glycidyl ester epoxy compound (jER871) was reduced from 5 parts by weight to 2 parts by weight, obtaining Conductive composition (43).

### Comparative Example 11

Comparative Example 11 was performed in the same manner as in Example 2 except that 95 parts by weight of the silver particle (LS0305@WA) was replaced with 57 parts by weight of Metal particle (1) and 38 parts by weight of silver particle (Ag-2556), obtaining Conductive composition (44).

### Comparative Example 12

Comparative Example 12 was performed in the same manner as in Example 8 except that 95 parts by weight of the silver particle (LS0305@WA) was replaced with 57 parts by weight of Metal particle (1) and 38 parts by weight of silver particle (Ag-2556), obtaining Conductive composition (45).

### Comparative Example 13

Comparative Example 13 was performed in the same manner as in Example 14 except that 95 parts by weight of the silver particle (LS0305@WA) was replaced with 57 parts by weight of Metal particle (1) and 38 parts by weight of silver particle (Ag-2556), obtaining Conductive composition (46).

### Comparative Example 14

Comparative Example 14 was performed in the same manner as in Example 2 except that 95 parts by weight of the silver particle (LS0305@WA) was replaced with 57 parts by weight of Metal particle (1) and 38 parts by weight of silver particle (SF-70A), obtaining Conductive composition (47).

### Comparative Example 15

Comparative Example 15 was performed in the same manner as in Example 8 except that 95 parts by weight of the silver particle (LS0305@WA) was replaced with 57 parts by weight of Metal particle (1) and 38 parts by weight of silver particle (SF-70A), obtaining Conductive composition (48).

### Comparative Example 16

Comparative Example 16 was performed in the same manner as in Example 14 except that 95 parts by weight of the silver particle (LS0305@WA) was replaced with 57 parts by weight of Metal particle (1) and 38 parts by weight of silver particle (SF-70A), obtaining Conductive composition (49).

Preparation of conductive layer and properties analysis Conductive compositions (1)-(3) of Examples 1-3, Conductive compositions (7)-(9) of Examples 7-9, and Conductive compositions (34)-(37) of Comparative Examples 1-4 were prepared to form a conductive layer individually, and the thermal conductivity coefficient, shear strength, and resistivity of the obtained conductive layer were measured, and the results are shown in Table 3.

The method for determining thermal conductivity coefficient included following steps. First, the conductive composition was coated on a release film to form a coating (with a thickness about 1 mm to 2 mm). Next, the release film having the coating was baked at 70° C. for 30 minutes and 200° C. for 1.5 hours. After cooling, the release film was cut to form a test sample (with a size of 1 cm×1 cm). Next, the thermal conductivity coefficient of the test sample was measured by a laser flash thermal diffusivity analyzer (NETZSCH LF447) according to ASTM E1461.

The method for determining shear strength included following steps. First, the conductive composition was coated on a silver-plated copper substrate (with a size of 3 cm×3 cm) to form a coating via blade coating. Next, a silver-plated aluminum oxide substrate (with a size of 3 mm×3 mm) was bonded with the silver-plated copper substrate via the coating. Next, 0.2N normal force was applied on the silver-plated aluminum oxide substrate, so that the coating was adjusted to have an average thickness of 20 m, obtaining a lamination. Next, the lamination was baked at 70° C. for 30 minutes and at 200° C. for 1.5 hours. After cooling, a test sample was obtained. Next, the shear strength (between the silver-plated aluminum oxide substrate and the silver-plated copper substrate) of the test sample was measured by shear tester (Condor Sigma, commercially available from XYZTEC).

The method for determining resistivity included following steps. First, the conductive composition was coated on the glass substrate to form a coating (with a size of 1 cm×1 cm) by screen printing. Next, the glass substrate was baked at 70° C. for 30 minutes and 200° C. for 1.5 hours to form a film on the glass substrate. After cooling, the resistivity of the film was measured by a four-point probe resistance meter (LORESTA-AX, commercially available from Mitsubishi Chemical Co.).

TABLE 3

| | | | metal | thermal | | |
|---|---|---|---|---|---|---|
| | | | particle:epoxy | conductivity | shear | |
| | epoxy | | compound | coefficient | strength | resistivity |
| | compound | metal particle | (weight ratio) | (W/mK) | (MPa) | (Ω · cm) |
| Example 1 | Glycidyl | LS0305@ | 97:3 | 130.2 | 61.8 | 5.4 × 10⁻⁶ |
| | methacrylate | WA | | | | |
| Example 2 | Glycidyl | LS0305@ | 95:5 | 128.8 | 58.6 | 7.2 × 10⁻⁶ |
| | methacrylate | WA | | | | |
| Example 3 | Glycidyl | LS0305@ | 93:7 | 113.6 | 53.7 | 8.9 × 10⁻⁶ |
| | methacrylate | WA | | | | |
| Example 7 | diglycidyl 1,2- | LS0305@ | 97:3 | 95.8 | 65.1 | 9.4 × 10⁻⁶ |
| | cyclohexane | WA | | | | |
| | dicarboxylate | | | | | |
| Example 8 | diglycidyl 1,2- | LS0305@ | 95:5 | 90.5 | 64.7 | 2.3 × 10⁻⁵ |
| | cyclohexane | WA | | | | |
| | dicarboxylate | | | | | |
| Example 9 | diglycidyl 1,2- | LS0305@ | 93:7 | 76.2 | 49.2 | 6.1 × 10⁻⁵ |
| | cyclohexane | WA | | | | |
| | dicarboxylate | | | | | |
| Comparative | 3,4- | LS0305@ | 95:5 | 72.8 | 22.4 | 5.1 × 10⁻⁵ |
| Example 1 | epoxycyclo- | WA | | | | |
| | hexylmethyl | | | | | |
| | methacrylate | | | | | |
| Comparative | Bis(3,4- | LS0305@ | 95:5 | 16.5 | 37.9 | 4.2 × 10⁻⁴ |
| Example 2 | epoxycyclo- | WA | | | | |
| | hexylmethyl) | | | | | |
| | adipate | | | | | |
| Comparative | 1,10- | LS0305@ | 95:5 | 28.4 | 19.6 | 7.8 × 10⁻⁵ |
| Example 3 | decanediol | WA | | | | |
| | diacrylate | | | | | |
| Comparative | bisphenol A | LS0305@ | 95:5 | 2.4 | 35.2 | 8.4 × 10⁻⁴ |
| Example 4 | epoxy resin | WA | | | | |
| | (EPON ® 828) | | | | | |

As shown in Table 2 and FIG. 11, a blue shift in the carbonyl signal of glycidyl methacrylate in the conductive compositions of Examples 1-3 was observed, and a sintering combination of metal particles was also observed after subjecting the conductive compositions of Examples 1-3 to sintering process. When the degree of sintering combination of metal particles is increased, the internal heat conduction of the conductive layer is also increased, thereby enhancing the thermal conductivity coefficient. In addition, when the degree of sintering combination of metal particles is increased, the bonding strength between the silver-plated aluminum oxide substrate and the silver-plated copper substrate would be improved, thereby enhancing the shear strength. Furthermore, when the degree of sintering combination of metal particles is increased, the conductive network density of the conductive layer would be increased, thereby reducing the resistivity.

As shown in Table 3, the conductive layers prepared from the conductive compositions of Examples 1-3 exhibit high thermal conductivity coefficient (greater than 110 W/mK), high shear strength (greater than 50 MPa), and low resistivity (less than 9×10⁻⁶ Ω·cm). In comparison with the conductive compositions of Examples 1-3, the conductive compositions of Examples 7-9 replaced glycidyl methacrylate with diglycidyl 1,2-cyclohexane dicarboxylate. As shown in Table 2 and FIG. 12, a blue shift in the carbonyl signal of diglycidyl 1,2-cyclohexane dicarboxylate in the conductive compositions of Examples 7-9 was also observed, and a sintering combination of metal particles was also observed after subjecting the conductive compositions of Examples 7-9 to sintering process.

As shown in Table 3, the conductive layer prepared from the conductive compositions of Examples 7-9 also exhibits high thermal conductivity coefficient, high shear strength, and low resistivity. In comparison with the conductive compositions of Examples 2, the conductive compositions of Comparative Example 1 replaced glycidyl methacrylate with 3,4-epoxycyclohexylmethyl methacrylate. As shown in Table 2 and FIG. 16, a blue shift in the carbonyl signal of diglycidyl 3,4-epoxycyclohexylmethyl methacrylate in the conductive compositions of Comparative Example 1 was 1 cm⁻¹, and the metal particle remains in the form of a particle after sintering process. Therefore, the conductive layer prepared from the conductive composition of Comparative Example 1 exhibits poor thermal conductivity coefficient and shear strength (as shown in Table 3).

In addition, since the Comparative Examples 2-4 did not employ the specific epoxy compound of the disclosure, no blue shift in the carbonyl signal was observed (i.e. no coordination formed between the epoxy compounds disclosed in Comparative Examples 2-4 and metal particles). Therefore, the conductive layers prepared from the conductive compositions of Comparative Examples 2-4 exhibit poor thermal conductivity coefficient and shear strength.

The conductive compositions (4)-(6) of Examples 4-6 and the conductive compositions (1)-(12) of Examples 10-12 were prepared to form conductive layers, and the thermal conductivity coefficient, shear strength, and resistivity of the conductive layers were measured, and the results are shown in Table 4.

TABLE 4

| | | | metal | thermal | | |
|---|---|---|---|---|---|---|
| | | | particle:epoxy | conductivity | shear | |
| | epoxy | | compound | coefficient | strength | resistivity |
| | compound | metal particle | (weight ratio) | (W/mK) | (MPa) | (Ω · cm) |
| Example 4 | Glycidyl | Metal particle | 97:3 | 129.3 | 59.1 | 4.1 × 10⁻⁶ |
| | methacrylate | (1) | | | | |
| Example 5 | Glycidyl | Metal particle | 95:5 | 121.2 | 60.2 | 6.7 × 10⁻⁶ |
| | methacrylate | (1) | | | | |
| Example 6 | Glycidyl | Metal particle | 93:7 | 99.7 | 50.1 | 8.5 × 10⁻⁶ |
| | methacrylate | (1) | | | | |
| Example 10 | diglycidyl | Metal particle | 97:3 | 91.2 | 58.9 | 1.8 × 10⁻⁵ |
| | 1,2- | (1) | | | | |
| | cyclohexane | | | | | |
| | dicarboxylate | | | | | |
| Example 11 | diglycidyl | Metal particle | 95:5 | 87.4 | 54.3 | 3.7 × 10⁻⁵ |
| | 1,2- | (1) | | | | |
| | cyclohexane | | | | | |
| | dicarboxylate | | | | | |
| Example 12 | diglycidyl | Metal particle | 93:7 | 70.7 | 48.7 | 5.9 × 10⁻⁵ |
| | 1,2- | (1) | | | | |
| | cyclohexane | | | | | |
| | dicarboxylate | | | | | |

As shown in Table 4, the conductive compositions of Examples 4-6 and 10-12 included the epoxy compound of the disclosure and the metal particle of the disclosure. Therefore, the conductive layers prepared from the conductive compositions of Examples 4-6 and 10-12 exhibited high thermal conductivity coefficient (greater than 70 W/mK), high shear strength (greater than 48 MPa), and low resistivity (less than 6×10⁻⁵ Ω·cm).

The conductive compositions (13)-(15) of Examples 13-15 and the conductive compositions (42) and (43) of Comparative Examples 9 and 10 were prepared to form conductive layers. The thermal conductivity coefficient, shear strength, and resistivity of the conductive layers were measured, and the results are shown in Table 5.

TABLE 5

| | | | metal | thermal | | |
|---|---|---|---|---|---|---|
| | | | particle:epoxy | conductivity | shear | |
| | epoxy | | compound | coefficient | strength | resistivity |
| | compound | metal particle | (weight ratio) | (W/mK) | (MPa) | (Ω · cm) |
| Example 13 | glycidyl | LS0305@WA | 97:3 | 98.1 | 65.1 | 1.6 × 10⁻⁵ |
| | ester epoxy | | | | | |
| | compound | | | | | |
| | (jER871) | | | | | |
| Example 14 | glycidyl | LS0305@WA | 95:5 | 89.04 | 63.2 | 5.4 × 10⁻⁵ |
| | ester epoxy | | | | | |
| | compound | | | | | |
| | (jER871) | | | | | |
| Example 15 | glycidyl | LS0305@WA | 93:7 | 67.4 | 53.1 | 8.1 × 10⁻⁵ |
| | ester epoxy | | | | | |
| | compound | | | | | |
| | (jER871) | | | | | |
| Comparative | glycidyl | LS0305@WA | 92:8 | 5.4 | 2.3 | 5.2 × 10⁻¹ |
| Example 9 | ester epoxy | | | | | |
| | compound | | | | | |
| | (jER871) | | | | | |

| | | | | |
|---|---|---|---|---|
| Comparative | glycidyl | LS0305@WA | 98:2 | No layer was formed due |
| Example 10 | ester epoxy | | | to high viscosity |
| | compound | | | |
| | (jER871) | | | |

In comparison with Examples 13-15, the weight ratio of the metal particle to the epoxy compound in the conductive composition of Comparative Example 9 was adjusted to 92:8. Since the metal particle was encapsulated by excessive epoxy compound, the conductive layer prepared from the conductive composition of Comparative Example 9 exhibited poor thermal conductivity coefficient, poor shear strength and high resistivity, as shown in Table 5.

In comparison with Examples 13-15, the weight ratio of the metal particle to the epoxy compound in the conductive composition of Comparative Example 10 was adjusted to 98:2. As a result, the conductive composition could not be prepared to form a conductive layer, due to the greatly increased viscosity of the conductive composition. In addition, when increasing the amount of the solvent in the conductive composition to reduce the viscosity thereof (for example the amount of solvent was increased from 5 parts by weight to 20 parts by weight), the conductive layer prepared from the conductive composition would have void defects due to the volatilization of excessive solvent in the baking process.

The conductive compositions (16)-(18) of Examples 16-18 and the conductive compositions (38)-(41) of Comparative Examples 5-8 were prepared to form conductive layers. The thermal conductivity coefficient, shear strength, and resistivity of the conductive layers were measured, and the results are shown in Table 6.

TABLE 6

| | | | metal | thermal | | |
|---|---|---|---|---|---|---|
| | | | particle:epoxy | conductivity | shear | |
| | epoxy | | compound | coefficient | strength | resistivity |
| | compound | metal particle | (weight ratio) | (W/mK) | (MPa) | (Ω · cm) |
| Example 16 | glycidyl | Metal particle | 97:3 | 95.7 | 60.7 | 2.7 × 10⁻⁵ |
| | ester epoxy | (1) | | | | |
| | compound | | | | | |
| | (jER871) | | | | | |
| Example 17 | glycidyl | Metal particle | 95:5 | 87 | 59.1 | 4.1 × 10⁻⁵ |
| | ester epoxy | (1) | | | | |
| | compound | | | | | |
| | (jER871) | | | | | |
| Example 18 | glycidyl | Metal particle | 93:7 | 65.2 | 48.5 | 8.9 × 10⁻⁵ |
| | ester epoxy | (1) | | | | |
| | compound | | | | | |
| | (jER871) | | | | | |
| Comparative | glycidyl | LS0305@PA01 | 95:5 | 32.1 | 37.6 | 5.3 × 10⁻⁵ |
| Example 5 | ester epoxy | | | | | |
| | compound | | | | | |
| | (jER871) | | | | | |
| Comparative | glycidyl | LS0305@HA05 | 95:5 | 6.3 | 13.2 | 4.8 × 10⁻⁴ |
| Example 6 | ester epoxy | | | | | |
| | compound | | | | | |
| | (jER871) | | | | | |
| Comparative | glycidyl | LS0305@SA05 | 95:5 | 5.1 | 9.2 | 5.2 × 10⁻⁴ |
| Example 7 | ester epoxy | | | | | |
| | compound | | | | | |
| | (jER871) | | | | | |
| Comparative | glycidyl | SI11000-10 | 95:5 | 2.8 | 7.3 | 6.8 × 10⁻⁴ |
| Example 8 | ester epoxy | | | | | |
| | compound | | | | | |
| | (jER871) | | | | | |

In comparison with Examples 16-18, the conductive compositions of Comparative Examples 5-7 replaced the metal particle having lower residual percentage of modified layer at 200° C. (about 0.19%) with the metal particle having higher residual percentage of modified layer at 200° C. (about greater than 0.39%).

In the combination of epoxy compound and metal particle disclosed in Comparative Examples 5-7, since the used metal particle had a higher residual percentage of the modified layer at 200° C. (greater than or equal to 0.39%), the sintering properties of metal particle would not be improved (remaining in the form of a particle) (as shown in FIGS. 3, 7 and 10), even though that there is a blue shift (2 cm⁻¹ to 5 cm⁻¹) in the carbonyl signal.

Therefore, as shown in Table 6, the conductive layers prepared from the conductive compositions of Comparative Examples 5-7 exhibited poor thermal conductivity coefficient, poor shear strength and high resistivity. The silver particle (with a trade number of SI11000-10) used in the conductive composition of Comparative Example 8 had a larger particle size (having a particle size distribution D90 of about 2.25 m). As shown in Table 2 and FIG. 19, the epoxy compound in the conductive composition of Comparative Example 8 could not form coordination with the silver particle, and the metal particle remained in the form of a particle after sintering process. Therefore, as shown in Table 6, the conductive layer prepared from the conductive composition of Comparative Example 8 exhibited poor thermal conductivity coefficient, poor shear strength and high resistivity.

The conductive compositions (19)-(24) of Examples 19-24 and the conductive compositions (31)-(33) of Examples 31-33 were prepared to form conductive layers. The thermal conductivity coefficient, shear strength, and resistivity of the conductive layers were measured, and the results are shown in Table 7.

TABLE 7

| | | | metal | thermal | | |
|---|---|---|---|---|---|---|
| | | | particle:epoxy | conductivity | shear | |
| | epoxy | | compound | coefficient | strength | resistivity |
| | compound | metal particle | (weight ratio) | (W/mK) | (MPa) | (Ω · cm) |
| Example 19 | Polymer (1) | LS0305@ | 97:3 | 95.1 | 61.7 | 5.1 × 10⁻⁵ |
| | (Mw: ~49,000 | WA | | | | |
| | g/mol) | | | | | |
| Example 20 | Polymer (1) | LS0305@ | 95:5 | 93.04 | 60.2 | 6.9 × 10⁻⁵ |
| | (Mw: ~49,000 | WA | | | | |
| | g/mol) | | | | | |
| Example 21 | Polymer (1) | LS0305@ | 93:7 | 73.2 | 52.1 | 9.2 × 10⁻⁵ |
| | (Mw: ~49,000 | WA | | | | |
| | g/mol) | | | | | |
| Example 22 | Polymer (1) | Metal particle | 97:3 | 90.1 | 57.4 | 6.1 × 10⁻⁵ |
| | (Mw: ~49,000 | (1) | | | | |
| | g/mol) | | | | | |
| Example 23 | Polymer (1) | Metal particle | 95:5 | 83.2 | 53.7 | 7.2 × 10⁻⁵ |
| | (Mw: ~49,000 | (1) | | | | |
| | g/mol) | | | | | |
| Example 24 | Polymer (1) | Metal particle | 93:7 | 69.2 | 49.1 | 8.7 × 10⁻⁵ |
| | (Mw: ~49,000 | (1) | | | | |
| | g/mol) | | | | | |
| Example 31 | Polymer (2) | Metal particle | 95:5 | 77.4 | 54.2 | 8.1 × 10⁻⁵ |
| | (Mw: ~53,000 | (1) | | | | |
| | g/mol) | | | | | |
| Example 32 | Polymer (3) | Metal particle | 95:5 | 69.1 | 49.7 | 9.4 × 10⁻⁵ |
| | (Mw: ~70,000 | (1) | | | | |
| | g/mol) | | | | | |
| Example 33 | Polymer (4) | Metal particle | 95:5 | 60.2 | 45.9 | 8.7 × 10⁻⁵ |
| | (Mw: ~84,000 | (1) | | | | |
| | g/mol) | | | | | |

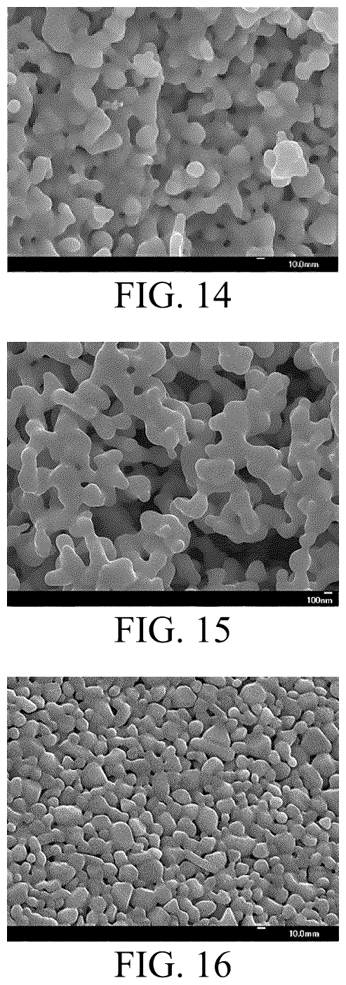

As shown in Table 2 and FIG. 14, the conductive composition o Examples 19-24 employed the specific epoxy compound (which could form coordination with the metal particle) and the specific metal particle (having lower residual percentage of modified layer at 200° C.). Therefore, the conductive layers prepared from the conductive compositions of Examples 19-24 exhibited high thermal conductivity coefficient, high shear strength, and low resistivity (as shown in Table 7). In addition, the conductive compositions of Examples 31-33 employed epoxy compounds with various molecular weight. As shown in Table 7, the conductive layers prepared from the conductive compositions of Examples 31-33 had a thermal conductivity coefficient greater than 60 W/mk, shear strength greater than 45 MPa, and resistivity less than 1×10⁻⁴ Ω·cm.

The conductive compositions (25)-(30) of Examples 25-30 and the conductive compositions (44)-(49) of Comparative Examples 11-16 were prepared to form conductive layers. The thermal conductivity coefficient, shear strength, and resistivity of the conductive layers were measured, and the results are shown in Table 8.

TABLE 8

| | | | 1^{st} metal | thermal | | |
|---|---|---|---|---|---|---|
| | | | particle:2^{nd} | conductivity | shear | |
| | epoxy | | metal particle | coefficient | strength | resistivity |
| | compound | metal particle | (weight ratio) | (W/mK) | (MPa) | (Ω · cm) |
| Example 25 | Glycidyl | Metal particle | 7:3 | 95.8 | 61.7 | 6.9 × 10⁻⁶ |
| | methacrylate | (1)/Ag-2556 | | | | |
| Example 26 | diglycidyl | Metal particle | 7:3 | 87.2 | 58.1 | 4.7 × 10⁻⁵ |
| | 1,2- | (1)/Ag-2556 | | | | |
| | cyclohexane | | | | | |
| | dicarboxylate | | | | | |
| Example 27 | glycidyl | Metal particle | 7:3 | 80.6 | 59.6 | 5.7 × 10⁻⁵ |
| | ester epoxy | (1)/Ag-2556 | | | | |
| | compound | | | | | |
| | (jER871) | | | | | |
| Example 28 | Glycidyl | Metal particle | 7:3 | 90.3 | 63.2 | 7.4 × 10⁻⁶ |
| | methacrylate | (1)/SF-70A | | | | |
| Example 29 | diglycidyl | Metal particle | 7:3 | 78.9 | 58.7 | 5.6 × 10⁻⁵ |
| | 1,2- | (1)/SF-70A | | | | |
| | cyclohexane | | | | | |
| | dicarboxylate | | | | | |
| Example 30 | glycidyl | Metal particle | 7:3 | 71.3 | 65.4 | 6.8 × 10⁻⁵ |
| | ester epoxy | (1)/SF-70A | | | | |
| | compound | | | | | |
| | (jER871) | | | | | |
| Comparative | Glycidyl | Metal particle | 6:4 | 48.6 | 30.5 | 5.2 × 10⁻⁵ |
| Example 11 | methacrylate | (1)/Ag-2556 | | | | |
| Comparative | diglycidyl | Metal particle | 6:4 | 41.7 | 27.3 | 5.1 × 10⁻⁵ |
| Example 12 | 1,2- | (1)/Ag-2556 | | | | |
| | cyclohexane | | | | | |
| | dicarboxylate | | | | | |
| Comparative | glycidyl | Metal particle | 6:4 | 43.2 | 25.9 | 6.7 × 10⁻⁵ |
| Example 13 | ester epoxy | (1)/Ag-2556 | | | | |
| | compound | | | | | |
| | (jER871) | | | | | |
| Comparative | Glycidyl | Metal particle | 6:4 | 41.1 | 23.4 | 5.7 × 10⁻⁵ |
| Example 14 | methacrylate | (1)/SF-70A | | | | |
| Comparative | diglycidyl | Metal particle | 6:4 | 32.4 | 21.1 | 6.1 × 10⁻⁵ |
| Example 15 | 1,2- | (1)/SA-70A | | | | |
| | cyclohexane | | | | | |
| | dicarboxylate | | | | | |
| Comparative | glycidyl | Metal particle | 6:4 | 30.2 | 19.7 | 7.4 × 10⁻⁵ |
| Example 16 | ester epoxy | (1)/SF-70A | | | | |
| | compound | | | | | |
| | (jER871) | | | | | |

The conductive compositions of Examples 25-30 and Comparative Examples 1-16 employed a first metal particle with a smaller particle size (having a particle size distribution D90 less than about 1 m) and a second metal particle with a larger particle size (having a particle size distribution D90 greater than about 2 m). As shown in Table 8, when the weight ratio of the first metal particle to the second metal particle was 70:30, the conductive layers prepared from the conductive compositions of Examples 25-30 had a thermal conductivity coefficient greater than 70 W/mk, shear strength greater than 55 MPa, and resistivity less than 7×10⁻⁵ Ω·cm (as shown in Table 8). In addition, when the amount of second metal particle was increased (i.e. the weight ratio of the first metal particle to the second metal particle was adjusted from 70:30 to 60:40), the conductive layers (i.e. the conductive layers prepared from the conductive compositions of Comparative Examples 11-16) had obviously reduced thermal conductivity coefficient and shear strength (as shown in Table 8).

Accordingly, by means of the coordination between the specific epoxy compound and the metal particle having a specific residual percentage (of the modified layer on the surface of the metal particle) and a particular size, the diffusion distance between metal particles in the conductive composition of the disclosure is effectively increased after subjecting to a sintering process (such as atmospheric pressure sintering process), thereby improving the sintering properties of the metal particle. Therefore, the conductive layer of the disclosure exhibits a higher thermal conductivity coefficient, higher shear strength and lower resistivity.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A conductive composition, comprising:
3 to 7 parts by weight of a component (A), wherein the component (A) is an epoxy compound, wherein the epoxy compound is a compound having at least one glycidyloxycarbonyl group; and
93 to 97 parts by weight of a component (B), wherein the component (B) comprises a first metal particle, wherein the first metal particle has a particle size distribution D90 less than or equal to 1 m, wherein the total weight of the component (A) and component (B) is 100 parts by weight.

2. The conductive composition as claimed in claim 1, wherein the epoxy compound is 2,3-epoxypropyl formate, glycidyl acrylate, glycidyl methacrylate, glycidol acetate, glycidyl butyrate, glycidyl benzoate, neodecanoic acid glycidyl ester, palmitic acid glycidyl ester, stearic acid glycidyl ester, oleic acid glycidyl ester, linoleic acid glycidyl ester, linolenic acid glycidyl ester, bis(oxiranylmethyl) oxalate, diglycidyl 1,2-cyclohexanedicarboxylate, bis(2,3-epoxy propyl)cyclohex-4-ene-1,2-dicarboxylate, 4,5-epoxytetrahydrophthalic acid diglycidyl ester, bis(2,3-epoxypropyl) phthalate, bis(1,4-epoxypropyl) terephthalate, bis(2,3-epoxypropyl) adipate, dimer acid glycidyl ester having at least one glycidyloxycarbonyl group, polyacrylate having at least one glycidyloxycarbonyl group, polymethacrylate having at least one glycidyloxycarbonyl group, or a combination thereof.

3. The conductive composition as claimed in claim 1, wherein the epoxy compound is a reaction product of a compound (I) and a compound (II), wherein the compound (I) is glycidyl methacrylate, glycidyl acrylate, or a combination thereof, wherein the compound (II) is polyethylene glycol dimethacrylate, polypropylene glycol dimethacrylate, polyethylene glycol diacrylate, polypropylene glycol diacrylate, dipropylene glycol diacrylate (DPGDA), ethoxylated bisphenol-A dimethacrylate, ethoxylated bisphenol-A diacrylate, tricyclodecane dimethanol diacrylate, propoxylated neopentyl glycol diacrylate, tripropylene glycol diacrylate, or a combination thereof.

4. The conductive composition as claimed in claim 1, wherein the first metal particle includes a first metal core and a first modified layer, wherein the first modified layer covers the first metal core.

5. The conductive composition as claimed in claim 4, wherein the first metal core is silver, copper, gold, aluminum, platinum, nickel, palladium, tin, indium, bismuth, or a combination thereof.

6. The conductive composition as claimed in claim 4, wherein the first modified layer is derived from a first modifier, wherein the first modifier is C₆₋₂₀ carboxylic acid, C₆₋₂₀ primary amine, or a combination thereof.

7. The conductive composition as claimed in claim 6, wherein the first modifier is caproic acid, palmitic acid, stearic acid, oleic acid, butylamine, octylamine, oleylamine, or a combination thereof.

8. The conductive composition as claimed in claim 4, wherein the first modified layer of the first metal particle has a residual percentage at 200° C. that is less than or equal to 0.35%.

9. The conductive composition as claimed in claim 1, wherein the component (B) further comprises a second metal particle, wherein the second metal particle comprises a second metal core and a second modified layer, wherein the second modified layer covers the second metal core, wherein the second metal particle has a particle size distribution D90 greater than 1 m and less than 10 m.

10. The conductive composition as claimed in claim 9, wherein the second metal core is silver, copper, gold, aluminum, platinum, nickel, palladium, tin, indium, bismuth, or a combination thereof.

11. The conductive composition as claimed in claim 9, wherein the second modified layer is derived from a second modifier, wherein the modifier is C₆₋₂₀ carboxylic acid, C₆₋₂₀ primary amine, or a combination thereof.

12. The conductive composition as claimed in claim 9, wherein the second modified layer of the second metal particle has a residual percentage at 200° C. that is less than or equal to 0.35%.

13. The conductive composition as claimed in claim 9, wherein the weight ratio of the first metal particle to the second metal particle is 70:30 to 99:1.

14. The conductive composition as claimed in claim 9, wherein the first metal particle and the second metal particle independently are flaky shaped, ball shaped, bar shaped, or a combination thereof.

15. The conductive composition as claimed in claim 1, further comprising:
0.1 to 5 parts by weight of a component (C), wherein the component (C) is an initiator.

16. The conductive composition as claimed in claim 15, wherein the initiator is iodonium salt, sulfonium salt, diazonium salt, selenonium salt, pyridinium salt, ferrocenium salt, phosphonium salt, sulfonate, or a combination thereof.

17. The conductive composition as claimed in claim 1, further comprising:
1 to 5 parts by weight of a component (D), wherein the component (D) is a solvent.

18. The conductive composition as claimed in claim 17, wherein the solvent is water, diethylene glycol diethyl ether, diethylene glycol dimethyl ether, propylene glycol methyl ether acetate, diethylene glycol butyl ether acetate, ethylene glycol butyl ether, tetraethylene glycol dimethyl ether, tri(propylene glycol) methyl ether, 2,2,4-trimethyl-1,3-pentanediol monoisobutyrate, hexyl acetate, 2-ethyl-1,3-hexanediol, or a combination thereof.

19. A conductive layer, comprising a product of the conductive composition as claimed in claim 1 via a sintering process.

20. An electronic device, comprising:
a substrate;
an electronic element; and
a conductive layer disposed between the substrate and the electronic element, wherein the conductive layer is the conductive layer as claimed in claim 19.
